(19) United States
(12) Patent Application Publication
(10) Pub. No.: US 2009/0322985 A1
(43) Pub. Date: Dec. 31, 2009

(54) MULTI-PANEL TYPE LIQUID CRYSTAL DISPLAY DEVICE

(76) Inventor: Kiminori Mizuuchi, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/375,811

(22) PCT Filed: Aug. 30, 2007
(86) PCT No.: PCT/JP2007/066875

§ 371 Date: Mar. 25, 2009

(30) Foreign Application Priority Data
Sep. 1, 2006 (JP) 2006-237704

(51) Int. Cl. G02F 1/13357; G02F 1/133

(52) U.S. Cl. 349/62; 349/73

(57) ABSTRACT

There is provided a highly-reliable multi-panel LCD in which a plurality of liquid crystal display panel units having planar light source units disposed on their rear surfaces can be arranged in a flat plane or a curved plane, and a partial reduction in luminance or the like in a display device can be avoided. The multi-panel LCD comprises a plurality of liquid crystal display panel units (2), planar light source units (3) which are placed in close contact with the rear surfaces of the respective liquid crystal display panel units (2), a laser light source unit (5) which supplies laser light for illumination to the planar light source units (3), and an optical fiber unit (6) which guides the laser light from the laser light source unit (5) to each of the planar light source units (3), wherein the liquid crystal display panel units (2) are arranged in a predetermined arrangement to constitute the multi-panel, and the planar light source units (3) applies the laser light emitted from the optical fiber unit (6) onto the display surfaces of the liquid crystal display panel units (2).

### TECHNICAL FIELD

The present invention relates to a multi-panel type liquid crystal display device (hereinafter also referred to as multi-panel LCD) which supplies laser light from a laser light source to planar light source units, and illuminates liquid crystal display panel units using the planar light source units.

### BACKGROUND ART

A liquid crystal display device is required to have a large-sized screen and a high picture quality because it is utilized not only as a display device for a personal computer but also as a television. Such liquid crystal display device adopts a planar light source device for illuminating a liquid crystal display panel from its rear surface, and a cold cathode fluorescent tube is often used as a light source of the planar light source device. However, the cold cathode fluorescent tube has such a problem that the display performance of the liquid crystal display device is degraded due to heat generated from the cold cathode fluorescent tube. In recent years, the liquid crystal display device is required to have a higher picture quality with an increase in demand as a television receiver, and it is considered to use a light-emitting diode (LED) or the like.

As a first example, Patent Document 1 discloses, in order to avoid influence of heat generation, a light crystal display device which is illuminated with a backlight comprising a light source having a cold cathode fluorescent tube, a first light guide which has a wedge-shaped cross-section and constitutes a planar light source, a second light guide which is disposed at an end surface of the first light guide and supplies illumination light to the first light guide, and an optical fiber which connects the light source with the second light guide. In this way, the cold cathode fluorescent tube and the first light guide are connected by the optical fiber in contrast to the conventional configuration, thereby avoiding influence of heat generation from the cold cathode fluorescent tube and noise caused by application of a high-frequency voltage.

Meanwhile, as a second example, Patent Document 2 discloses a planar light source device using a light guide plate having a wedge-shaped cross section in order to realize reduction in size and weight of the device by reducing an invalid area in the light guide plate even when using a point light source such as an LED. The planar light source device using an LED is superior in color reproducibility and provides higher picture quality relative to the device using a cold cathode fluorescent tube.

Furthermore, as a third example, Patent Document 3 discloses a planar light source device which can uniform the luminance in a light-emitting plane using a small quantity of LEDs, in which a single optical waveguide connected to the LEDs is arranged meandering on the rear face of a light guide plate.

Moreover, there is also practically used a planar light source device which realizes a higher picture quality using not only LEDs of red(R) light, blue(B) light, and green(G) light but also LEDs emitting other colors. Further, a planar light source device in which some LEDs are replaced with semiconductor laser elements is also considered. This is because the semiconductor laser element has higher luminance and higher output power than the LED and therefore can realize a reduction in driving power and an increase in picture quality.

On the other hand, various configurations of multi-panel LCD in which a large-sized screen or a multi-screen is configured by planarly arranging a lot of liquid crystal panels have been developed and practically used. For example, as a fourth example, Patent Document 4 discloses a multi-panel LCD in which a plurality of liquid crystal display panel units are arranged like tiles, and linear fluorescent lamps are arranged on their rear surfaces so as to cross the plural liquid crystal display panel units to provide a planar light source device.

Patent Document 1: Japanese Published Patent Application No. Hei. 11-167808

Patent Document 2: Japanese Published Patent Application No. 2006-134661

Patent Document 3: Japanese Published Patent Application No. 2006-134720

Patent Document 4: National Publication of Translated Version No. 9-500461

### DISCLOSURE OF THE INVENTION

### Problems to be Solved by the Invention

While the above-described first example is provided with the light source which is disposed separately from the liquid crystal display device, it neither discloses nor suggests that plural liquid crystal display panels are unitized to realize a multi configuration. Further, while the second and third examples disclose that a uniform and high-luminance planar light source device is realized using LEDs to be used for a liquid crystal display device, also these examples neither disclose nor suggest that plural liquid crystal display panels are unitized to realize a multi configuration.

On the other hand, in the fourth example, a plurality of liquid crystal display panels are unitized and combined to provide a large-screen liquid crystal display device, and linear fluorescent tubes are arranged on the rear surfaces of the liquid crystal display panel units so as to cross the respective units to provide a planar light source device. Therefore, an increase in the screen size is restricted by the length of the fluorescent tubes, and moreover, uneven luminance and luminance reduction of the liquid crystal display device are likely to occur due to the lifetime of the fluorescent tubes because many fluorescent tubes are used, resulting in a difficulty in ensuring long-term reliability. Further, the liquid crystal display device of such configuration can be attached to only a single wall surface, that is, it cannot be attached to a curved surface to provide a curved-surface multi-panel liquid crystal display device as a whole, resulting in a lack of degree of freedom in application.

By the way, although in a television receiver or the like a large-sized screen is realized using a single liquid crystal display panel, a larger-screen display device is required in order to provide information and images simultaneously to an unspecified number of people in a public space or the like. Further, it is also required to provide more powerful pictures by arbitrarily performing planar or curved arrangement of the liquid crystal display panel units according to the space where the units are to be arranged. In order to meet these requests, it is necessary to minimize the joints between the plural liquid crystal display panel units, and simultaneously, reduce the size of the planar light source device disposed on the rear surface of the liquid crystal display panel to approximately the same size as the display panel. Moreover, when disposing LEDs or fluorescent tubes, it is not possible to secure sufficient reliability of the whole liquid crystal display device because the plural LEDs and fluorescent tubes have different light-emission luminances and different lifetimes.

The present invention is made to solve the above-described problems and has for its object to provide a highly-reliable multi-panel LCD which enables planar or curvature arrangement of plural liquid crystal display panel units having planar light source units on their rear surfaces, and can prevent such as a partial luminance reduction in the display device.

### Measures to Solve the Problems

In order to solve the above-described problems, according to claim 1 of the present invention, there is provided a multi-panel type liquid crystal display device comprising a plurality of liquid crystal display panel units which are placed in a predetermined arrangement to configure a multi-panel; a plurality of planar light source units which are placed in close contact with the rear surfaces of the respective liquid crystal display panel units, and illuminate the display surfaces of the liquid crystal display panel units; a laser light source unit which supplies laser light for illumination to the plural planar light source units; and an optical fiber unit which guides the laser light from the laser light source unit to each of the plural planar light source units.

Thereby, it is possible to illuminate the screen of the multi-panel uniformly in the multi-panel type liquid crystal display device comprising the plural liquid crystal display panel units arranged.

Furthermore, since the individual planar light source units are not provided with light sources, it is possible to avoid a reduction in quality or a reduction in lifetime as the whole device due to deterioration of light sources of some planar light source units. Further, it is possible to realize a multi-panel type liquid crystal display device which can be reduced in thickness because of less necessity of spaces for placing light sources in the planar light source units, and which does not generate heating of the liquid crystal display panel units due to light sources.

Furthermore, since the light is supplied from the light source which is connected with the planar light source units of the respective liquid crystal display panel units by the fiber, the degree of freedom in usage patterns of the multi-panel type liquid crystal display device can be significantly increased.

Furthermore, since the laser light source is used as the light source for illumination, space saving and thickness reduction of the multi-panel type liquid crystal display device can be achieved.

Furthermore, since the fiber and the laser light source are used, significant reduction in propagation loss of light and enhancement of utilization efficiency are achieved, resulting in significant reduction in power consumption.

Furthermore, since the laser light source is used, a multi-panel type liquid crystal display device having an excellent color reproducibility is realized.

According to claim 2 of the present invention, in the multi-panel type liquid crystal display device defined in claim 1, the planar light source unit comprises a flat main-surface incident type light guide plate which is closely connected to the liquid crystal display panel unit at one of its main surfaces, and guides the laser light from the other main surface; an optical fiber light guide part which is extended from the optical fiber unit, and arranged with being two-dimensionally drawn on the other main surface of the main-surface incident type light guide plate; and a transparent member which is disposed so as to contact with the other main surface of the main-surface incident type light guide plate and with the optical fiber light guide part, takes out the laser light from the contact portion with the optical fiber light guide part, and guides the taken laser light into the main-surface incident type light guide plate from the contact portion with the other main surface of the main-surface incident type light guide plate.

Thereby, since the laser light which is taken out from plural portions of the optical fiber light guide part extended from the optical fiber unit is applied to the main-surface incident type light guide plate, the display area of the liquid crystal display panel unit can be illuminated with uniform luminance.

Further, since in this configuration the planar light source unit can be configured in an approximately same size as the liquid crystal display panel unit, it is possible to prevent increase in the joints between the panels due to restriction by the planar light source units when the multi-panel configuration is adopted.

Furthermore, since the laser light can be easily taken out of the optical fiber by forming a curve of a small curvature in the fiber or by strongly pressing the fiber against a member having a large refractive index with its coating being removed, it is possible to supply the laser light from the optical fiber to the light source unit without providing a special space, and thereby the planar light source unit can be miniaturized and simplified.

According to claim 3 of the present invention, in the multi-panel type liquid crystal display device defined in claim 1, the planar light source unit comprises a flat main-surface incident type light guide plate which is closely connected to the liquid crystal display panel unit at one of its main surfaces, and guides the laser light from the other main surface; and an optical waveguide which is disposed so as to be two-dimensionally drawn in close contact with the other main surface of the main-surface incident type light guide plate, receives the laser light at its one end part and transits the laser light to the other end part, and guides the laser light from the other main surface of the main-surface incident type light guide plate into the main-surface incident type light guide plate.

Therefore, a thin planar light source unit can be realized by placing the optical waveguide in close contact with the main-surface incident type light guide plate. That is, since the laser light source has a very high luminance relative to the ordinary lamp or LED, it can be efficiently connected to a very thin fiber having a core diameter of about several 10 μm, and therefore, it can supply light to the fiber under the state where the power density of light is high. Thereby, the width required for the fiber can be suppressed to 100 μm or below even if the configuration of supplying light from the side surface of the light guide plate is adopted, and thus the joints of the light guide plate units can be made inconspicuous and the optical waveguide can be reduced in thickness.

According to claim 4 of the present invention, in the multi-panel type liquid crystal display device defined in claim 1, the planar light source unit comprises a flat end-surface incident type light guide plate which is closely connected to the liquid crystal display panel unit at its one main surface, and receives the laser light at its one end surface and emits the laser light from the one main surface; an optical path conversion part which is closely connected to the one end surface of the end-surface incident type light guide plate, and converts the optical path of the laser light; and a laser light guide part which takes out the laser light from the optical fiber unit to guide the laser light into the optical path conversion part.

According to claim 5 of the present invention, in the multi-panel type liquid crystal display device defined in claim 4, the laser light guide part comprises an optical member which takes out the laser light from the optical fiber unit; and a light guide plate for the conversion part, which receives the laser light emitted from the optical member at its one end surface, and guides the laser light from the other end surface into the optical path conversion part.

According to claim 6 of the present invention, in the multi-panel type liquid crystal display device defined in claim 5, the light guide plate for the conversion part has a reflection layer or a reflection and diffusion layer at its peripheral surface excluding the one end surface and the other end surface.

Further, in claims 4 to 6 of the present invention, the end-surface incident type light guide plate may be configured in a double-layer structure to realize a planar unit in which the laser light is sufficiently diffused in the in-plane direction by the first-layer light guide plate while it is planarly emitted from the surface of the second-layer light guide plate. Thus, the double-layered structure makes the light distribution uniform to realize a light source unit having a high in-plain uniformity. Since the laser light having a high luminance is used, the light can be coupled with a high efficiency even when the light guide plate is reduced in thickness to about several 100 μm. Thereby, a thin liquid crystal panel can be configured even when a multi-layered light guide plate is utilized.

According to claim 7 of the present invention, in the multi-panel type liquid crystal display device as defined in claim 5 or 6, the optical member includes a microlens array which expands the light flux of the laser light taken out of the optical fiber unit, and applies the laser light to the light guide plate for the conversion part.

Thereby, the laser light can be taken out from the end of the optical fiber lead part extended from the optical fiber unit to be applied to the optical path conversion part through the light guide plate for the conversion part, and thus the material composition and design of the planar light source unit including the end-surface incident type light guide plate can be facilitated.

According to claim 8 of the present invention, in the multi-panel type liquid crystal display device defined in claim 5 or claim 6, the optical member comprises a transparent member which contacts with an optical fiber lead part that is extended from the optical fiber unit and is disposed in parallel with the one end surface of the light guide plate for the conversion part, and takes out the laser light from the contact portion to apply the laser light onto the one end surface of the light guide plate for the conversion part.

Thereby, the laser light can be taken out from the contact portion of the optical fiber and the transparent member in the vicinity of the end of the optical fiber lead part extended from the optical fiber unit to be applied to the optical path conversion part through the light guide plate for the conversion part, and thus the material composition and design of the planar light source unit including the end-surface incident type light guide plate can be facilitated.

According to claim 9 of the present invention, in the multi-panel type liquid crystal display device defined in claim 1, the planar light source unit comprises a flat end-surface incident type light guide plate which is closely connected to the liquid crystal display panel unit at its one main surface, and receives the laser light at its one end surface and emits the laser light from the one main surface; and a light guide member which is closely connected to the one end surface of the end-surface incident type light guide plate, and guides the laser light in the direction parallel to the one end surface to apply the laser light onto the one end surface of the end-surface incident type light guide plate.

Thereby, the configuration of the planar light source unit can be significantly simplified.

According to claim 10 of the present invention, in the multi-panel type liquid crystal display device defined in any of claims 1 to 9, the optical fiber unit comprises a bundle of plural optical fibers, and one ends of the optical fibers are placed on the laser light source side while the other ends of the optical fibers are placed in the respective planar light source units.

Thereby, the laser light from the laser light source unit can be branched and taken into the plural optical fibers to be supplied to the respective planar light source units, and thus the laser light sources in the laser light source unit can be easily replaced when they are deteriorated.

According to claim 11 of the present invention, in the multi-panel type liquid crystal display device defined in claim 10, optical switches for selectively guiding the laser light to each of the optical fibers are disposed between the optical fiber unit and the laser light source unit.

According to claim 12 of the present invention, in the multi-panel type liquid crystal display device defined in claim 11, each of the optical switches is provided with a light amount control part for controlling the light transmission amount of the laser light to each of the optical fibers.

According to claim 13 of the present invention, the multi-panel type liquid crystal display device defined in claim 11 or 12 further includes a display control circuit for controlling the respective image displays of the multi-panel, and an optical switch control circuit for controlling the optical switches on the basis of a signal from the display control circuit, and when selectively displaying the liquid crystal display panel units, the optical switch control circuit turns on the optical switches based on the signal from the display control circuit so as to cut the guided laser light for the liquid crystal display panel units not to be displayed.

According to claim 14 of the present invention, the multi-panel type liquid crystal display device defined in claim 12 further includes a display control circuit for controlling the respective image displays of the multi-panel, and a light amount control circuit for controlling the light amount control parts on the basis of a signal from the display control circuit, and the light amount control circuit controls the amount of the laser light guided to the liquid crystal display panel units by using the light amount control units.

By adopting the above-described configurations, the light can be selectively turned off with respect to the liquid crystal display panel unit which is not required to be displayed. Alternatively, by controlling the amounts of laser lights supplied to the respective liquid crystal display panel units with the light amount control parts, the brightness of the entire multi-panel can be made uniform, or the luminance of only a specific liquid crystal display panel unit can be increased to brighten its display screen or conversely reduced to darken the screen. Furthermore, when selectively turning off the light or when controlling the amount of laser light, it can be controlled based on the signal from the display control circuit.

According to claim 15 of the present invention, in the multi-panel type liquid crystal display device defined in any of claims 1 to 9, the optical fiber unit comprises an optical fiber; and a light branch part which is placed close to the planar light source unit, branches the laser light to take out the same from the optical fiber, and guides the laser light to the planar light source unit.

Thereby, one or a few optical fibers can be drawn to be branched into plural optical fibers in the vicinity of the planar light source unit, and thereby a fine optical fiber can be used.

According to claim 16 of the present invention, in the multi-panel type liquid crystal display device defined in any of claims 1 to 15, the laser light source unit includes at least a laser light source which emits red laser light, a laser light source which emits blue laser light, and a laser light source which emits green laser light.

Thereby, full-color display can be realized. Further, full-color display with a higher color reproducibility can be realized by using not only red, blue, and green light sources but also laser light sources of different wavelengths.

According to claim 17 of the present invention, in the multi-panel type liquid crystal display device defined in claim 16, the laser light source unit includes a multiplexing mechanism which multiplexes the laser lights emitted from the plural laser light sources to make a single beam.

Thereby, the configuration of the optical fiber unit can be simplified.

According to claim 18 of the present invention, in the multi-panel type liquid crystal display device defined in claim 1, each of the planar light source units includes an input light connector which receives laser light, an output light connector which outputs the laser light, and an optical fiber which connects the input light connector and the output light connector, and the laser light outputted from the laser light source unit is guided to the respective planar light source units of the respective liquid crystal display panel units which constitute a multi-panel, through the input light connectors, the output light connectors, and the optical fibers connecting these connectors.

Thereby, the configuration of the whole multi-panel type liquid crystal display device can be simplified.

According to claim 19 of the present invention, the multi-panel type liquid crystal display device defined in Claim 1 further includes a detector for detecting the reflected light intensity of the laser light supplied to the optical fiber of the fiber unit, and the intensity of the laser light supplied to the optical fiber is controlled according to the reflected light intensity.

Thereby, when breakage of the fiber or the panel occurs, this breakage can be detected by a change in the reflected light intensity of the laser light supplied to the optical fiber, and the laser light supplied to the optical fiber can be controlled, thereby avoiding leakage of light from the breakage point to secure the safety.

According to claim 20 of the present invention, in the multi-panel type liquid crystal display device defined in claim 1, the optical fiber of the optical fiber unit is a multi-mode fiber.

Thereby, speckle noise caused by interference of the laser can be reduced.

### Effects of the Invention

According to the present invention, in the multi-panel LCD configured by combining the liquid crystal display panel units, since the illumination light for the planar light source units is supplied from the laser light source unit which is placed in a different position, the screen of the multi-panel can be uniformly illuminated. Further, since the individual planar light source units are not provided with light sources in contrast to the conventional configuration, it is possible to avoid a reduction in quality and a reduction in lifetime as the whole device due to light sources. Moreover, since the laser light source is used, a multi-panel LCD excellent in color reproducibility can be realized.

### BRIEF DESCRIPTION OF THE DRAWINGS

FIG. 1 is a schematic diagram for explaining a multi-panel LCD according to a first embodiment of the present invention, which is viewed from the display surface side of liquid crystal display panel units.

FIG. 2(a) is a partial view obtained by extracting only one column of the multi-panel LCD of the first embodiment, which is a plane view seen from the planar light source unit side, and FIG. 2(b) is a cross-sectional view taken along a line 2B-2B shown in FIG. 2(a).

FIG. 3 is a cross-sectional view for explaining the configuration of a display unit of the multi-panel LCD of the first embodiment.

FIG. 4(a) is a diagram for explaining the configuration for taking laser light from an optical fiber to a transparent member, and FIG. 4(b) is a diagram for explaining another configuration for taking laser light from the optical fiber to the transparent member.

FIG. 5(a) is a diagram for explaining the configurations of a laser light source and an optical fiber used in the multi-panel LCD of the first embodiment, which is a perspective view showing the outer appearance, and FIG. 5(b) is a schematic view showing the internal structures of the laser light source and the optical fiber.

FIG. 6 is a schematic diagram showing a laser light source in which branch units are configured by plural waveguide type optical switches in the multi-panel LCD of the first embodiment.

FIG. 7 is a diagram illustrating the configuration wherein optical switches are provided between the laser light source and the optical fiber, wherein FIG. 7(a) shows the configuration in which optical switches are provided between the laser light source and the optical fiber shown in FIG. 5, and FIG. 7(b) shows the configuration in which optical switches are provided between the laser light source and the optical fiber shown in FIG. 6.

FIG. 8 is a partial view obtained by extracting only one column in the multi-panel for explaining the configuration of a multi-panel LCD according to a modification of the first embodiment, which is a plan view seen from the planar light source unit side, and FIG. 8(b) is an enlarged view of a portion A shown in FIG. 8(a).

FIG. 9 is a diagram for explaining the configuration of a multi-panel LCD according to another modification of the first embodiment.

FIG. 10(a) is a diagram for explaining a multi-panel LCD according to a second embodiment of the present invention, which is a plan view seen from the planar light source unit side, and FIG. 10(b) is a cross-sectional view taken along a line 10B-10B shown in FIG. 10(a).

FIG. 11(a) is a diagram for explaining the configuration of a display unit of the multi-panel LCD of the second embodiment, which is a plan view seen from the planar light source unit 41 side, and FIG. 11(b) is a cross-sectional view taken along a line 11B-11B shown in FIG. 11(a).

FIG. 12(a) is a diagram for explaining the configuration of a multi-panel LCD according to a third embodiment of the present invention, which is a plan view seen from the planar light source unit side, and FIG. 12(b) is a cross-sectional view taken along a line 12B-12B shown in FIG. 12(a).

FIG. 13(a) is a diagram for explaining the configuration of a display unit of the multi-panel LCD of the third embodiment, which is a plan view seen from the planar light source unit side, and FIG. 13(b) is a cross-sectional view taken along a line 13B-13B shown in FIG. 13(a).

FIG. 14(a) is a diagram illustrating the configuration of a display unit used in a multi-panel LCD according to a modification of the third embodiment, which is a plan view seen from the planar light source unit side, and FIG. 14(b) is a cross-sectional view taken along a line 14B-14B shown in FIG. 14(a).

FIG. 15(a) is a diagram for explaining the configuration of a multi-panel LCD according to a fourth embodiment of the present invention, which is a plan view seen from the planar light source unit side, and FIG. 15(b) is a cross-sectional view taken along a line 15B-15B shown in FIG. 15(a).

FIG. 16(a) is a diagram for explaining the configuration of a display unit of the multi-panel LCD of the fourth embodiment, which is a plan view seen from the planar light source unit side, and FIG. 16(b) is a cross-sectional view taken along a line 16B-16B shown in FIG. 16(a).

FIG. 17 is a diagram for explaining the configuration of a multi-panel LCD according to a fifth embodiment of the present invention, which is a plan view seen from the planar light source unit side.

FIG. 18(a) is a diagram for explaining the configuration of a display unit of the multi-panel LCD of the fifth embodiment, which is a plan view seen from the planar light source unit side, and FIG. 18(b) is a cross-sectional view taken along a line 18B-18B shown in FIG. 18(a).

FIG. 19 is a diagram for explaining the configuration of a multi-panel LCD according to a sixth embodiment of the present invention.

FIG. 20 is a diagram for explaining the configuration of a multi-panel LCD according to a seventh embodiment of the present invention.

### DESCRIPTION OF REFERENCE NUMERALS

100,200,300,400,500 . . . multi-panel type liquid crystal display device (multi-panel LCD)
2 . . . liquid crystal display panel unit
3,36,41,51,61,76,90 . . . planar light source unit
4,250,350,360,450,550 . . . display unit
5,28 . . . laser light source unit
6 . . . optical fiber unit
7,33 . . . optical fiber unit
8 . . . transparent member
9,42 . . . main-surface incident type light guide plate
10,16 . . . polarization film
11,15 . . . glass substrate
12 . . . pixel
12a . . . red pixel part (R sub-pixel)
12b . . . green pixel part (G sub-pixel)
12c . . . blue pixel part (B sub-pixel)
13 . . . liquid crystal
14 color filter
14a . . . R filter
14b . . . G filter
14c . . . B filter
17 . . . seal layer
18 . . . multiplexing mechanism
19 . . . red laser light source
20 . . . green laser light source
21 . . . blue laser light source
22,23 . . . wavelength selection mirror
24 . . . branch unit
25 . . . beam splitter
26,64 . . . reflection mirror
27 . . . waveguide type optical switch
29,30 . . . optical switch
34a,34b,34c,37a,70 . . . optical fiber light guide part
35a,35b,35c . . . light branch part
38a,38b,38c,39a,39b,39c,71 . . . optical fiber lead part
43 . . . optical waveguide
44 . . . reflection layer
45 . . . transparent base
52,77 . . . end-surface incident type light guide plate
53,78 . . . first light guide plate
54,79 . . . second light guide plate
55,62 . . . optical path conversion part
56,63,72 . . . laser light guide unit
57 . . . optical member
58 . . . reflection mirror
59,65 . . . microlens array
60,67 . . . light guide plate for conversion part
66 . . . mirror driving mechanism
80 . . . light guide member
81 . . . junction part
82 . . . end surface
101 . . . planar light source unit
103 . . . optical fiber unit
104 . . . light source
105 . . . input light connector
106 . . . output light connector
107 . . . optical fiber
1801 . . . detector
1802 . . . multiplexing mechanism
1803 . . . optical fiber
1804 . . . return light
1805 . . . half mirror
1806 . . . beam splitter
1807 . . . reflection mirror

### BEST MODE TO EXECUTE THE INVENTION

Hereinafter, embodiments of the present invention will be described with reference to the drawings. The same elements are given the same reference numerals and are not described repeatedly.

### Embodiment 1

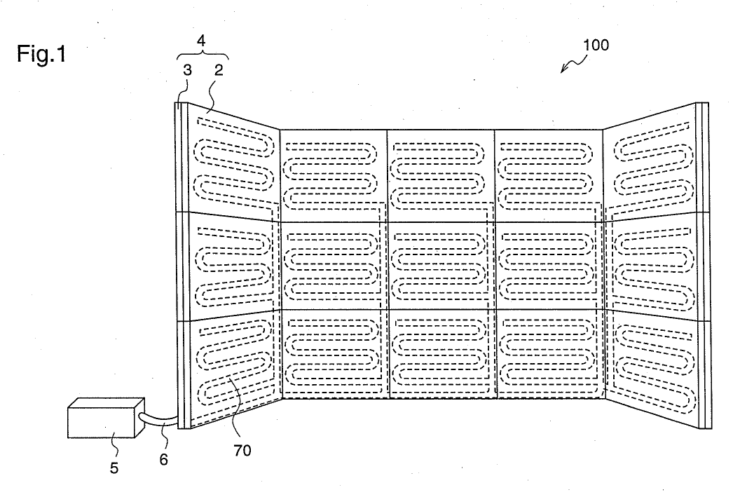

FIG. 1 is a schematic diagram for explaining a multi-panel LCD 100 according to a first embodiment of the present invention, which is viewed form the display surface side of liquid crystal display panel units 2. The multi-panel LCD 100 of this first embodiment is provided with a plurality of liquid crystal display panel units 2, planar light source units 3 which are disposed in close contact with the rear surfaces of the respective liquid crystal display panel units 2, a laser light source unit 5 which supplies laser light for illumination to the planar light source units 3, and an optical fiber unit 6 which guides the laser light emitted from the laser light source unit 5 to the respective planar light source units 3. The liquid crystal display panel units 2 are arranged in a predetermined arrangement to constitute a multi-panel, and the planar light source units 3 illuminate the display surfaces of the liquid crystal display panel units 2 with the laser light emitted from the optical fiber unit 6. The optical fiber unit 6 comprises a bundle of plural optical fibers, and one end of the optical fiber unit is disposed on the laser light source unit 5 side while the other end thereof is disposed in a meandering pattern on the rear surfaces of the respective planar light source units 2 as shown in FIG. 1, thereby to constitute an optical fiber light guide part 70.

In the multi-panel LCD 100 of this first embodiment, display units 4 each comprising the liquid crystal display panel unit 2 and the planar light source unit 3 being combined are arranged by three planes in the vertical direction and five planes in the horizontal direction, i.e., 15 units are arranged in total. Further, as shown in FIG. 1, the units in the first and fifth columns are bent inward. The multi-panel LCD of the present invention is not restricted to the configuration shown in FIG. 1, and it may have a configuration in which a larger number of display units 4 are combined. Alternatively, it may have a configuration in which a plurality of display units 4 are planarly arranged. Moreover, the display units 4 may be arranged so that the whole multi-panel has a curved configuration.

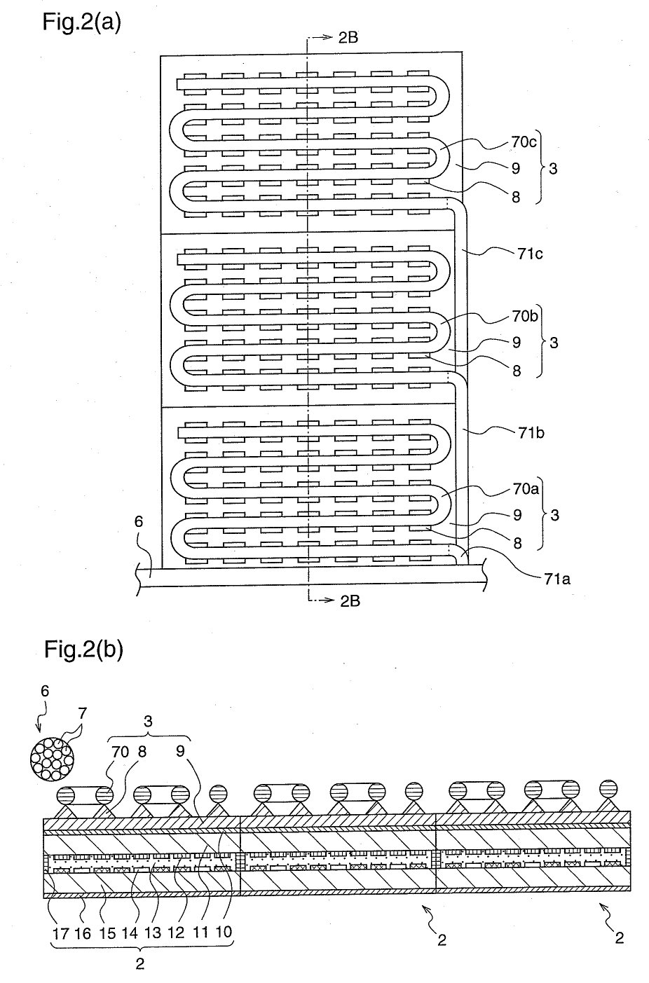

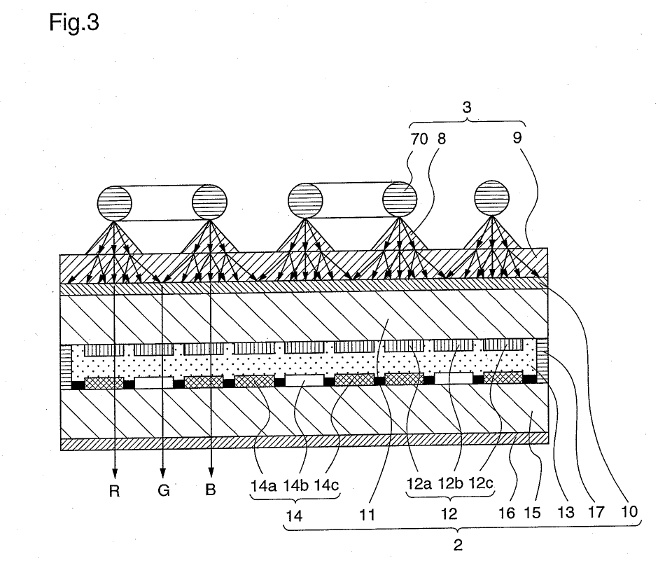

Next, a description will be given of the specific configuration of the multi-panel LCD 100 shown in FIG. 1. FIG. 2 is a partial view obtained by extracting only one column for explaining the configuration of the multi-panel LCD 100 shown in FIG. 1, wherein FIG. 2(a) is a plan view seen from the planar light source unit 3 side, and FIG. 2(b) is a cross-sectional view taken along a line 2B-2B in FIG. 2(a). Further, FIG. 3 is a cross-sectional view for explaining the configuration of the display unit 4 of the multi-panel LCD 100. Hereinafter, the configuration of the multi-panel LCD 100 of this first embodiment will be described with reference to these figures.

The liquid crystal display panel unit 2 is transparent or semi-transparent and has, for example, a TFT active matrix structure. A plurality of pixels 12 each comprising a red pixel (R sub-pixel) 12a, a green pixel (G sub-pixel) 12b, and a blue pixel (B sub-pixel) 12c are disposed in a display area as shown in FIG. 3, and these pixels are driven by TFTs. A liquid crystal 13 is disposed between two glass substrates 11 and 15, and TFTs (not shown) for driving the liquid crystal 13 are disposed on either of the glass plates 11 and 15. Further, an R filter 14a, a G filter 14b, and a B filter 14c which constitute a color filter 14 are disposed at the positions corresponding to the R sub-pixel 12a, the G sub-pixel 12b, and the B sub-pixel 12c of the pixel 12, respectively. Furthermore, polarization films 10 and 16 whose polarization axes are perpendicular to each other are disposed on the outer surfaces of the two glass substrates 11 and 15, respectively.

The peripheral regions of the two glass substrates 11 and 15 are sealed with a sealing layer 17, thereby to seal up the liquid crystal 13. Since this sealing layer 17 appears like a joint between panels when configuring the multi-panel, it is desired to be minimized. Further, an area for connecting the TFTs to a driver (not shown) which drives the TFTs must be provided on the glass substrate 11 where the TFTs are disposed. This connection area also becomes a joint between panels when configuring the multi-panel. In the multi-panel LCD 100 of this first embodiment, the liquid crystal display panel units which have conventionally been used are adopted as the panel units 2. Therefore, further description will be omitted.

The planar light source unit 3 of the multi-panel LCD 100 of this first embodiment is configured as follows. That is, the planar light source unit 3 includes a flat main-surface incident type light guide plate 9 having one of main surfaces being closely connected to the liquid crystal display panel unit 2 and the other main surface from which laser light is guided. Further, the planar light source unit 3 includes an optical fiber light guide part 70 which is extended from an optical fiber lead part 71 that is branched from the optical fiber unit 6 and is two-dimensionally drawn on the other main surface of the main-surface incident type light guide plate 9. The planar light source unit 3 further includes a transparent member 8 disposed between the main-surface incident type light guide plate 9 and the optical fiber light guide part 70, and the transparent member 8 contacts the optical fiber light guide part 70 at plural portions to take the laser light from the respective contact portions, and guides the laser light from the other main surface of the main-surface incident type light guide plate 9 into the main-surface incident type light guide plate 9.

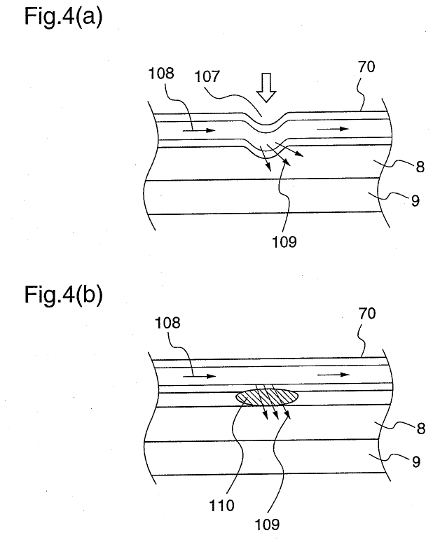

The optical fiber light guide part 70 is branched from the optical fiber unit 6 comprising a bundle of optical fibers 7 and is arranged in a meander pattern on the other main surface of the main-surface incident type light guide plate 9. Laser lights of red light (R light), green light (G light), and blue light (B light) which are multiplexed are guided into the optical fiber light guide part 70. The transparent member 8 has a wedge shape, and the apex of the wedge contacts the optical fiber light guide part 70 while the bottom of the wedge is closely connected to the main-surface incident type light guide plate 9. When a pressure is applied to the optical fiber light guide part 70 in the area contacting the apex of the transparent member 8, the optical fiber light guide part 70 is distorted at a portion 107 as shown in FIG. 4(a). By setting the curvature radius of this distorted portion 107 to 1 cm or less, laser light 108 leaks from the distorted portion 107 into the transparent member 8 as shown by arrows 109 to be applied to the main-surface incident type light guide plate 9. This main-surface incident type light guide plate 9 has the function of uniformizing the incident light while scattering the same, and applying the light from the other main surface to the liquid crystal display panel unit 2. A diffusion plate may be provided between the main-surface incident type light guide plate 9 and the liquid crystal display panel unit 2. Further, as for the contact portion of the optical fiber light guide part 70 with the apex of the transparent member 8, the coating of the optical fiber light guide part 70 may be partially removed and the uncoated portion may be adhered to the apex of the transparent member 8 with a adhesive agent 110 as shown in FIG. 4(b) instead of applying a pressure to the optical fiber light guide part 70. By adopting such configuration, the laser light 108 leaks from the adhered portion into the transparent member 8 as shown by arrows 109 and enters in the main-surface incident type light guide plate 9. The adhesive agent 110 is desired to have a refraction index higher than that of the optical fiber light guide part 70.

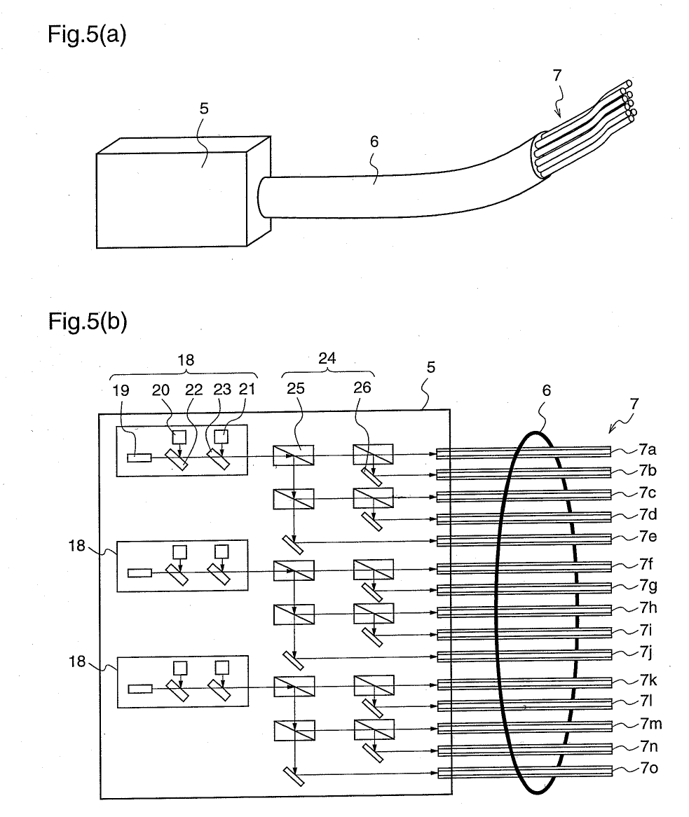

Next, a description will be given of the specific configurations of the laser light source unit 5 and the optical fiber unit 6 of the multi-panel LCD according to the first embodiment. FIG. 5 is a diagram for explaining the configurations of the laser light source unit 5 and the optical fiber unit 6 used in the multi-panel LCD of the first embodiment, wherein FIG. 5(a) is a perspective view showing the outer appearance, and FIG. 5(b) is a schematic view showing the internal structures of the laser light source unit 5 and the optical fiber unit 6.

As shown in FIG. 5(a), the optical fiber unit 6 is connected to the laser light source unit 5, and the optical fiber unit 6 is obtained by bundling individual optical fibers 7 together. As shown in FIG. 5(b), the laser light source unit 5 is configured including plural multiplexing mechanisms 18 and plural branch units 23. Each multiplexing mechanism 18 has the function of multiplexing laser lights which are emitted from a red laser light source 10, a green laser light source 20, and a blue laser light source 21 into a single beam through wavelength selection mirrors 22 and 23. The wavelength selection mirror 22 transmits the red laser light and reflects the green laser light, while the wavelength selection mirror 23 transmits the red laser light and green laser light and reflects the blue laser light. Each branch unit 24 is composed of beam splitters 25 and reflection mirrors 26 for guiding the laser light emitted from the multiplexing mechanism 18 to the individual optical fibers 7a to 7o. This branch unit 24 has the function of dividing the laser light emitted from the multiplexing mechanism 18 by the beam splitters 25 and the reflection mirrors 26, and guiding the laser lights to the respective optical fibers 7a to 7o.

For example, the laser light emitted from the multiplexing mechanism 18 is divided into two laser lights having the same output intensity by the beam splitter 25 disposed first, and one of the laser lights is divided into two laser lights having the same output intensity by the beam splitter 25 disposed second. Then, one of the laser lights emitted from the second beam splitter 25 is guided to the first optical fiber 7a among the optical fibers 6, while the other laser light is reflected by the reflection mirror 29 to be guided. to the second optical fiber 7b. Other beam splitters 25 and reflection mirrors 26 function similarly, and thereby the laser lights having the same output intensity are guided to the respective optical fibers 7. In the laser light source unit 5 shown in FIG. 5(b), five laser beams are obtained by one set of the multiplexing mechanism 18 and the branch unit 24, and these five laser lights are guided to the different optical fibers 7, respectively. As shown in FIG. 5(b), the laser lights are guided from the three multiplexing mechanisms 18 to the optical fibers 7a to 7o.

By adopting such configuration, in the multi-panel LCD 100 of this first embodiment, the shape of the planar light source unit 3 can be configured in an approximately same size as the liquid crystal display panel unit 2, and the laser light can be uniformly applied over the entire display surface of the liquid crystal display panel unit 2. Accordingly, even when the multi-panel configuration is adopted, a joint between panels is restricted by only the seal layer 17 of the liquid crystal display panel unit 2 and the connection area for connecting the driver to the TFT, and it is not restricted by the planar light source unit 3, thereby realizing a multi-panel LCD having inconspicuous joints.

Further, in the multi-panel LCD 100 of this first embodiment which is configured by combining a plurality of liquid crystal display panel units, illumination light which illuminates the panel LCD from its rear surface is supplied from the laser light source which is common to the plural liquid crystal panel units and is located in a place separated from the planar light source units, and therefore, the screen of the multi-panel can be uniformly illuminated.

Further, since light sources are not disposed in the individual planar light source units in contrast to the conventional configuration, it is possible to avoid a reduction in quality and a reduction in lifetime as the whole device due to deterioration of light sources of some planar light source units. Further, since the light source and the planar light source units of the respective liquid crystal panel units are connected by the fibers to supply light to the respective planar light source units through the fibers, the degree of freedom in usage patterns of the multi-panel LCD can be significantly increased. Furthermore, since light sources are not disposed in the planar light source units of the respective display units, spaces for placing light sources are not required in the planar light source units, and thereby a reduction in the thickness of the device can be achieved. Further, since light sources are not disposed in the planar light source units, a multi-panel LCD in which the liquid crystal display panel units are not heated by light sources can be realized.

In this first embodiment, since the laser light source is used as a light source for illuminating the multi-panel LCD from its rear surface, space saving and thickness reduction in the multi-panel LCD can be realized. In the case where the light source is disposed in a place separated from the planar light source units, if an ordinary lamp or LED is used as the light source, the size of the light emitting point of the light source becomes about 1 mm. In order to efficiently couple this light with the fiber or the waveguide tube, the diameter of the fiber or the waveguide tube must be larger than the size of the light emitting point, i.e., several mm. Further, in order to separately supply R, G, B lights to the respective planar light source units of the liquid crystal display panel units from the light source which is disposed in a place separated from the planar light source units, and independently control the lights supplied to the respective liquid crystal display panel units, fibers as many as three times the number of panels are required, and thereby the size of the fiber bundle becomes several 10 mm or more, resulting in a very thick bundle. In order to draw such bundle from the light source to the respective planar light source units, a thick space is required on the rear surface of the panel, and further, a considerably thick wiring is required between the light source and the panel. Moreover, the joints of panels are also increased. In contrast to this, when the laser light source is adopted, the size of the light emission point is about 10 μm, and thereby the fiber diameter can be suppressed to about 100 μm, and the diameter of the fiber bundle can be suppressed to about several mm. Thereby, the wiring is downsized and the space for drawing the wiring at the rear surface of the panel is saved. Thus, even when a plurality of panels are used, downsizing and thickness reduction of the device can be achieved by using the laser light source. Further, since the propagation loss of light is significantly reduced by using the fibers and the laser light source, the utilization efficiency is enhanced to significantly reduce the power consumption. Further, according to the first embodiment, a multi-panel LCD excellent in color reproducibility can be realized by using the laser light source.

Further, even in the multi-panel configuration, it is only required to provide the red laser light source 19, the green laser light source 20, and the blue laser light source 21 each by threes as the light sources for the planar light source units 3 as shown in FIG. 5(b), and moreover, these laser light sources are disposed in a place separated from the planar light source units 3. Therefore, these light sources can be easily replaced even when luminance reduction or insufficient emission occurs. While in the example shown in FIG. 5 the laser lights are supplied to the fifteen planar light source units 3 using the red laser light source 19, the green laser light source 20, and the blue laser light source 21 each by threes, the present invention is not restricted thereto. The red, blue, and green laser light sources may be provided each by one, or twos, or fours or more. The number of laser light sources can be arbitrarily set according to the number of the display units 4 and the emission powers of the laser light sources.

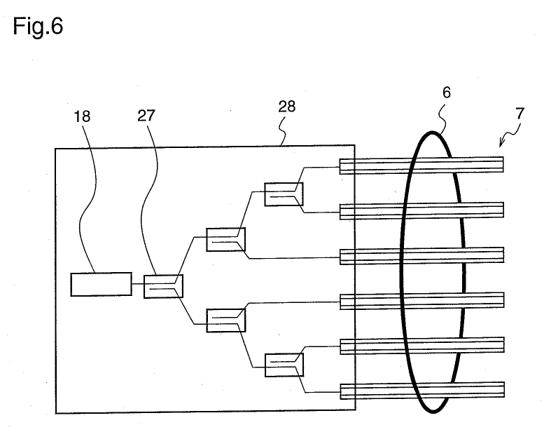

Further, while in the configuration of the laser light source unit 5 and the optical fiber 6 shown in FIG. 5(b) the branch unit 24 is composed of the beam splitters 25 and the reflection mirrors 26, a configuration shown in FIG. 6 may be adopted. FIG. 6 is a schematic diagram illustrating a laser light source unit 28 in which branch units are implemented by plural waveguide type optical switches 27. In FIG. 6, laser light emitted from the multiplexing mechanism 18 is branched into two laser lights by each waveguide type optical switch 27 to be finally guided to the optical fibers 7. The laser light source unit 28 of such configuration may be used.

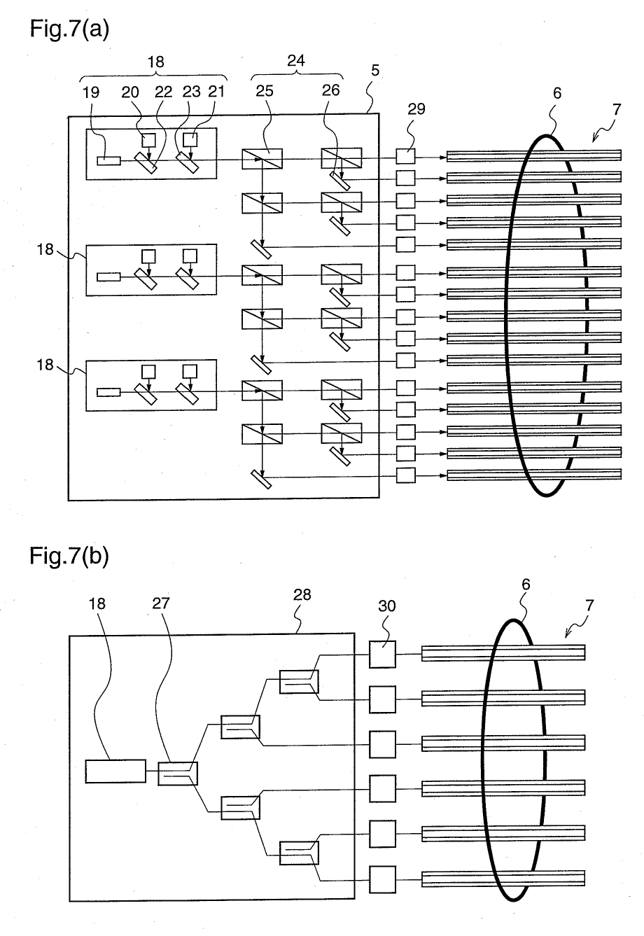

FIG. 7 is a diagram illustrating a configuration having optical switches provided between the laser light source unit 5 and the optical fiber unit 6, wherein FIG. 7(a) shows a configuration wherein optical switches 29 are provided between the laser light source unit 5 and the optical fiber unit 6 shown in FIG. 5, and FIG. 7(b) shows a configuration wherein optical switches 30 are provided between the laser light source unit 20 and the optical fiber unit 6 shown in FIG. 6.

As shown in FIGS. 7(a) and 7(b), the optical switches 29 and 30 for selectively guiding the laser lights to the respective optical fibers 7 are disposed between the optical fiber unit 6 and the laser light source unit 5, respectively. More specifically, FIG. 7(a) shows the configuration in which the branched laser lights outputted from the branch units 24 are guided through the optical switches 29 to the optical fibers 7, and FIG. 7(b) shows the configuration in which the branched laser lights outputted from the branch units comprising the waveguide type optical switches 27 are guided through the optical switches 30 to the optical fibers 7. It is possible to block the laser lights to arbitrary optical fiber 7 by placing the optical switches 29 and 30 in front of the respective optical fibers 7.

Further, the optical switches 29 and 30 may be provided with light amount control parts (not shown) for controlling the transmission amounts of laser lights to the respective optical fibers 7. Further, a display control circuit (not shown) for controlling the image display of the multi-panel and an optical switch control circuit (not shown) for controlling the optical switches 29 or 30 on the basis of a signal supplied from the display control circuit may be provided. When selectively displaying the liquid crystal display panel units 2, the optical control circuit may turn on the optical switches 29 or 30 according to the signal from the display control circuit so as to block the guided laser lights to the liquid crystal display panel units not to be displayed.

Further, a light amount control circuit (not shown) for controlling the light amount control parts (not shown) on the basis of a signal from the display control circuit may be provided. The light amount control circuit controls the amounts of laser lights to be guided to the liquid crystal display panel units 2 on the basis of the signal from the display control circuit by using the light amount control parts. By adopting such configuration, it is possible to, based on the signal from the display control circuit, uniformize the luminance of the entire multi-panel, or increase the luminance of a specific liquid crystal display panel unit to brighten its display screen, or conversely decrease the luminance to darken the screen. As the result, the display quality of the display screen in the multi-panel configuration can be significantly improved.

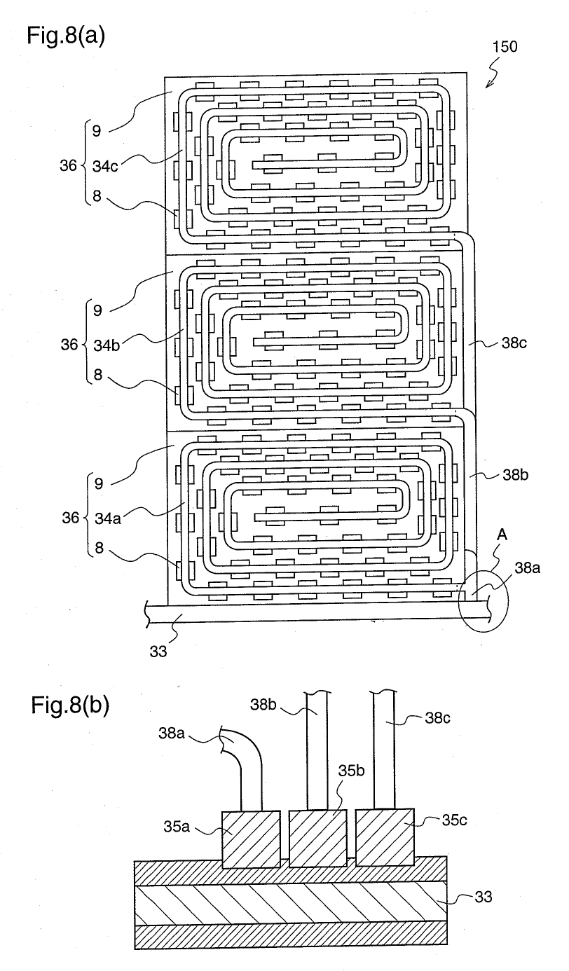

FIG. 8 is a diagram illustrating the configuration of a multi-panel LCD 150 according to a modification of the first embodiment, wherein FIG. 8(a) is a plan view of only one column which is extracted from the multiple panels of the multi-panel LCD and viewed from the planar light source unit 36 side, and FIG. 8(b) is an enlarged view of a portion A shown in FIG. 8(a). The multi-panel LCD of this modification is characterized by that the optical fiber unit for guiding the laser light emitted from the laser light source unit comprises a single optical fiber 33, and light branch parts 35a, 35b, and 35c placed close to the planar light source units 36, which take out and branch the laser light from the optical fiber 33, and guide the laser lights to the planar light source units.

The laser lights taken out of the light branch parts 35a, 35b, and 35c are transmitted through optical fiber leading parts 38a, 38b, and 38c and guided by optical fiber light guide parts 34a, 34b, and 34c of the respective planar light source units 36, and further, guided through the transparent members 8 to the main-surface incident type light guide plates 9. In the multi-panel LCD of this modification, the optical fiber light guide parts 34a, 34b, and 34c are spirally arranged as shown in FIG. 8. Other constituents are identical to those of the multi-panel LCD of the first embodiment shown in FIG. 2.

In the modification shown in FIG. 8, since the optical fiber unit is composed of the single optical fiber 33, the configuration for guiding the laser light from the laser light source unit to the optical fiber 33 as the optical fiber unit can be simplified. The light branch parts are not restricted to those shown in FIG. 8(b). For example, the optical fiber lead parts 38a, 38b, and 38c may be directly fusion-bonded to the optical fiber 33 to take out the laser lights, and the taken out laser lights may be guided to the optical fiber light guide parts 34a, 34b, and 34c which are disposed on the surfaces of the main-surface incident type light guide plates 9.

While in this first embodiment the R, G, and B laser lights are multiplexed by the multiplexing mechanism to be guided as a single laser beam to the optical fiber unit, the R, G, and B laser lights may be respectively guided by different optical fiber units to be incident on the planar light source unit as the R light, the G light, and the B light. This configuration can also be applied to a field sequential system liquid crystal display.

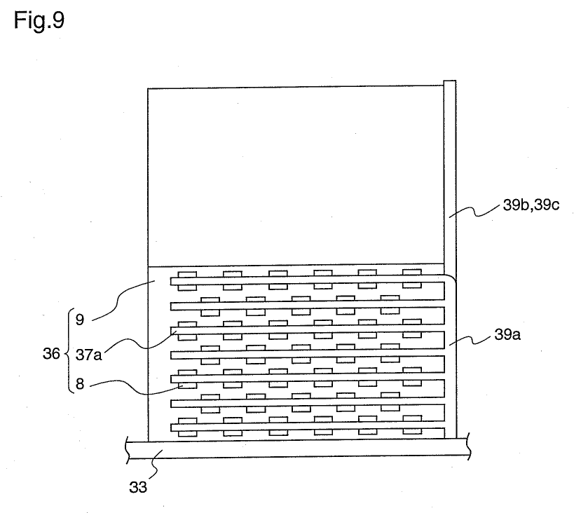

Further, while in this embodiment the optical fiber which is arranged in a meandering pattern or a spiral pattern is brought into contact with the transparent member to take out the laser light, the present invention is not restricted thereto. For example, as shown in FIG. 9, a plurality of optical fiber light guide parts 37 may be extended from the optical fiber unit 33 through the optical fiber lead part 39 to one planar light source unit to be arranged at constant pitches on the rear surface of the planar light source unit.

### Embodiment 2

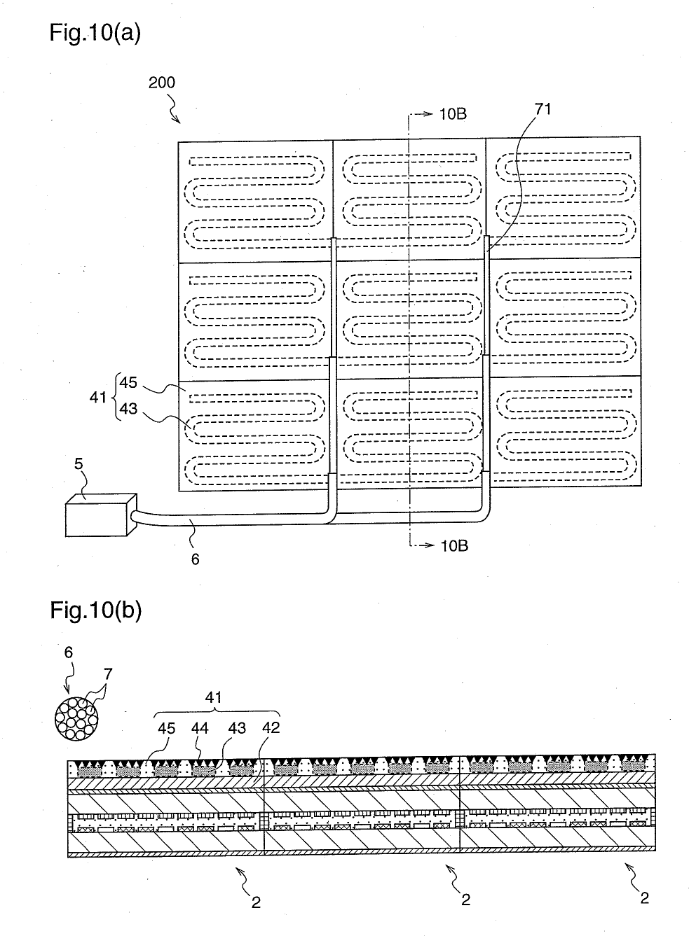

FIG. 10 is a diagram for explaining a multi-panel LCD 200 according to a second embodiment of the present invention, wherein FIG. 10(a) is a plan view seen from the planar light source unit side, and FIG. 10(b) is a cross-sectional view taken along a line 10B-10B shown in FIG. 10(a).

The multi-panel LCD 200 of this second embodiment is provided with a plurality of liquid crystal display panel units 2, planar light source units 41 which are arranged in close contact with the rear surfaces of the respective liquid crystal display panel units 2, a laser light source unit 5 which supplies laser light for illumination to the planar light source units 41, and an optical fiber unit 6 which guides the laser light emitted from the laser light source unit 5 to the respective planar light source units 41. The multi-panel is configured by arranging vertically 3×horizontally 3 pieces (9 pieces in total) of display units each comprising a liquid crystal display panel unit 2 and a planar light source unit 41, and the planar light source units 41 are configured so as to illuminate the display surfaces of the liquid crystal display panel units 2 with the laser light emitted from the optical fiber unit 6. As for the configurations of the laser light source unit 5 and the optical fiber unit 6, the various configurations described for the first embodiment can be similarly used.

Each planar light source unit 41 is configured as follows. That is, it includes a flat main-surface incident type light guide plate 42 which is closely connected to the liquid crystal display panel unit 2 at one of its main surfaces, and guides the laser light from the other main surface. The planar light source unit 41 further includes an optical waveguide 43 which is arranged so as to be two-dimensionally drawn on and closely connected to the other main surface of the main-surface incident type light guide plate 42, receives, at its one end, the laser light that is guided through the optical fiber lead part 71 which is led from the optical fiber unit 6 to transmit the laser light to the other end, and guides the laser light from the other main surface of the main-surface incident type light guide plate 42 into the main-surface incident type light guide plate 42. The optical waveguide 43 is formed in a meandering shape in a transparent base 45 such as glass or plastic, and has a reflection layer 44 on its surface opposite to the main-surface incident type light guide plate 42.

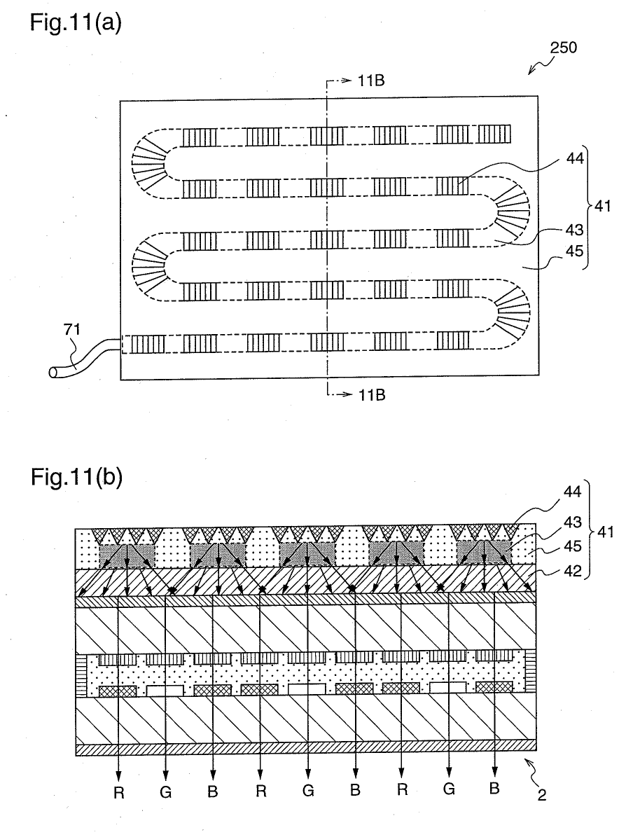

FIG. 11 is a diagram illustrating the configuration of a display unit 250 of the multi-panel LCD 200 according to the second embodiment of the present invention, wherein FIG. 11(a) is a plan view seen from the planar light source unit 41 side, and FIG. 11(b) is a cross-sectional view taken along a line 11B-11B shown in FIG. 11(a). The configuration of the multi-panel LCD 200 of this second embodiment will be described in detail with reference to FIG. 11.

The optical waveguide 43 in the transparent base 45 can be obtained by forming a layer having a high refraction index in the transparent base 45. Such high refraction index layer can be formed by introducing an impurity by ion injection or diffusion. Alternatively, it can also be obtained by forming a meandering concave pattern in the transparent base 45, and filling the concave pattern with a transparent substance having a refraction index higher than that of the periphery. The reflection layers 44 can be formed by damaging the area where the optical waveguide 43 is formed at constant pitches by using such as sandblast or etching. By forming such reflection layers 44, the laser light can be applied to the main-surface incident type light guide plate 42 from the optical waveguide 43 in the area where the reflection layers 44 are formed. The main-surface incident type light guide plate 42 has the function of uniformizing the incident light while scattering the same, and applying the light from the other main surface to the liquid crystal display panel unit 2. A diffusion plate may be provided between the main-surface incident type light guide plate 42 and the liquid crystal display panel unit 2. Further, reflection films such as aluminum may be formed on the damaged surfaces of the transparent base. Such reflection films can prevent leakage of the laser light, and thereby the laser light can be guided more efficiently to the main-surface incident type light guide plate 41.

As shown in FIG. 11(b), also in the multi-panel LCD 200 of this second embodiment, the shape of the liquid crystal display panel unit 2 can be made approximately the same as that of the planar light source unit 41. Thereby, the laser light can be uniformly applied over the entire display surface of the liquid crystal display panel unit 2. Accordingly, even when the multi-panel configuration is adopted, a joint between panels is restricted by only the seal layer of the liquid crystal display panel unit 2 and the connection area for connecting the driver with the TFT, and it is not restricted by the planar light source unit 41, thereby realizing a multi-panel LCD having inconspicuous joints.

### Embodiment 3

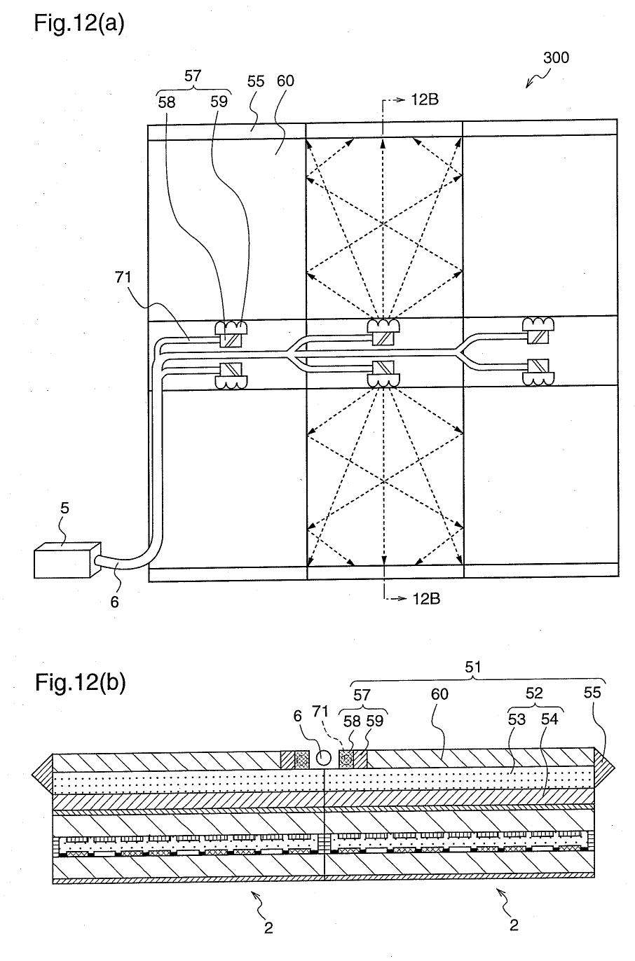

FIG. 12 is a diagram for explaining the configuration of a multi-panel LCD 300 according to a third embodiment of the present invention, wherein FIG. 12(a) is a plan view seen from the planar light source unit side, FIG. 12(b) is a cross-sectional view taken along a line 12B-12B shown in FIG. 12(a). In the multi-panel LCD 300 of this third embodiment, the display units each comprising the liquid crystal display panel unit 2 and the planar light source unit 51 are arranged by two planes in the vertical direction and three planes in the horizontal direction, i.e., six units in total.

The multi-panel LCD 300 of this third embodiment comprises a plurality of liquid crystal display panel units 2, a plurality of planar light source units 51 which are arranged in close connection with the rear surfaces of the respective liquid crystal display panel units 2, a laser light source unit 5 which supplies illumination laser light to the planar light source units 51, and an optical fiber unit 6 which guides the laser light from the laser light source unit 5 to the respective planar light source units 51. As for the configurations of the laser light source unit 5 and the optical fiber unit 6, the various configurations described for the first embodiment can be similarly used.

The planar light source unit 51 includes a flat main-surface incident type light guide plate 52 which is closely connected to the liquid crystal display panel unit 2 at one of its main surfaces, and receives the laser light from one of its end surfaces and outputs the laser light from the other main surface, an optical path conversion part 55 which is closely connected to the one end surface of the main-surface incident type light guide plate 52 and converts the optical path of the laser light, and a laser light guide unit 56 which guides the laser light emitted from the optical fiber unit 6 into the optical path conversion part 55. As shown in the figure, the laser light is guided to the laser light guide unit 56 from an end of the optical fiber lead part 71 that is led from the optical fiber unit 6.

Further, the laser light guide unit 56 includes an optical member 57 which takes the laser light from the optical fiber unit 6, and a light guide plate 60 for the conversion part, which receives the laser light emitted from the optical member 57 at one of its end surfaces and outputs the laser light from the other end surface to the optical path conversion part 55. In this embodiment, the optical member 57 comprises a reflection mirror 58 and a microlens array 59, and expands the laser light along the width direction of the light guide plate 60 for the conversion part as shown in FIG. 12(a). The light guide plate 60 for the conversion part is provided with a reflection film (not shown) at its peripheral surface excluding the one end surface and the other end surface, the laser light guided into the light guide plate 60 for the conversion part is guided to the optical path conversion part 55 while being reflected at the peripheral surface. For example, an aluminum thin film or a silver thin film may be used as the reflection film. Further, a right angle prism or the like may be used as the optical path conversion part 55.

The end-surface incident type light guide plate 52 comprises a first light guide plate 53 which transmits the laser light emitted from the optical path conversion part 55 while reflecting and diffusing the same, and a second light guide plate 54 which scatters the laser light to uniformize the same.

As shown in FIG. 12(b), the planar light source unit 51 is disposed on the rear surface of the liquid crystal display panel unit 2. The optical path conversion part 55 of the planar light source unit 51 is disposed in the peripheral area which is not the joint between the display units. Further, the laser light guide part 57 and the light guide plate 60 for conversion part are disposed on the surface of the end-surface incident type light guide plate 52. Since the above-described arrangement is adopted, the liquid crystal display panel unit 2 can be made approximately the same in shape as the end-surface incident type light guide plate 52, and the joint between the display units can be made a size that is determined by such as the seal layer 17 of the liquid crystal display panel unit.

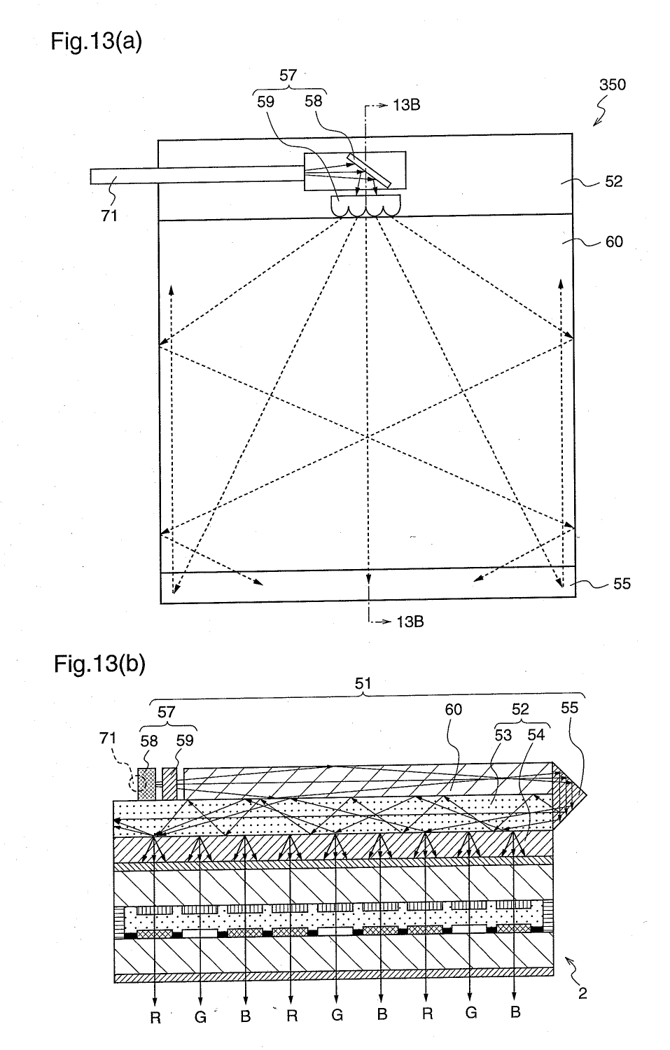

FIG. 13 is a diagram illustrating the configuration of the display unit 350 of the multi-panel LCD 300 of this third embodiment, wherein FIG. 13(a) is a plan view seen from the planar light source unit 51 side, and FIG. 13(b) is a cross-sectional view taken along a line 13B-13B shown in FIG. 13(a). The planar light source unit 51 which has approximately the same shape as the liquid crystal display panel unit 2 excluding the optical path conversion part 55 is disposed on the rear surface of the display panel unit 2.

The laser light emitted from the optical fiber lead part 71 is expanded by the reflection mirror 58 and the microlens array 59 of the laser light guide part 57 to be applied to the light guide plate 60 for conversion part. The laser light incident on the light guide plate 60 for conversion part is reflected and diffused at the peripheral surface and diffused to be applied to the optical path conversion part 55, and then the direction of the laser light is converted so that the laser light is applied to the first light guide plate 53 of the end-surface incident type light guide plate 52. Then, the laser light is reflected and diffused in the first light guide plate 53 to be applied to the second light guide plate 54. The laser light is diffused in the second light guide plate 54 so as to have a uniform luminance distribution over the entire surface, and thereafter, illuminates the liquid crystal display panel unit 2. Thereby, the screen is displayed.

As shown in FIGS. 12 and 13, in the multi-panel LCD 300 of this third embodiment, the planar light source unit 51 is configured such that only the optical path conversion part 55 protrudes over the liquid crystal display panel unit 2. However, by disposing the optical path conversion part 55 in the peripheral region as shown in FIG. 12 when configuring the multi-panel, the joint between panels is restricted by only the seal layer of the liquid crystal display panel unit 2 and the connection area for connecting the driver with the TFT, and it is not restricted by the planar light source unit 51, and thus a multi-panel LCD having inconspicuous joints can be realized.

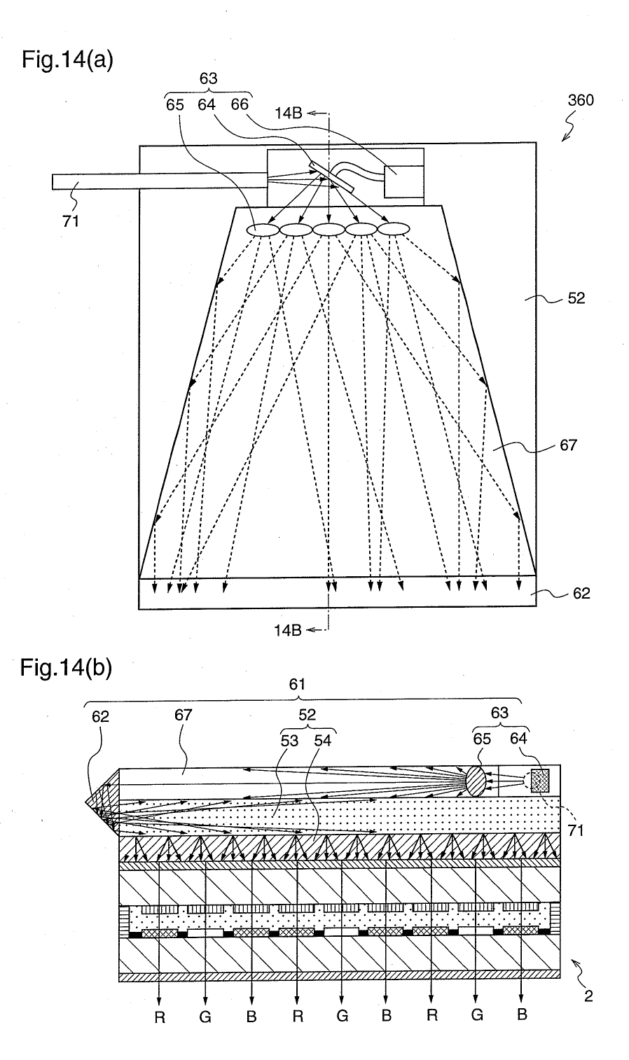

FIG. 14 is a diagram illustrating the configuration of a display unit 360 used in a multi-panel LCD according to a modification of the third embodiment, wherein FIG. 14(a) is a plan view seen from the planar light source unit 61 side, and FIG. 14(b) is a cross-sectional view taken along a line 14B-14B shown in FIG. 14(a). The arrangement of the display units in the multi-panel LCD of this modification is identical to that in the multi-panel LCD 300 of the third embodiment shown in FIG. 12.

The display unit 360 of the multi-panel unit LCD of this modification is identical to the display unit 350 of the multi-panel unit LCD 300 of the third embodiment except the configurations of the laser light guide part 63 and the light guide plate 67 for conversion part. Hereinafter, the configurations and functions of the laser light guide part 63 and the light guide plate 67 for conversion part will be mainly described.

In the multi-panel LCD of this modification, the laser light guide part 63 comprises a reflection mirror 64, a microlens array 65, and a mirror drive mechanism 66 for vibrating the reflection mirror 64. Further, the microlens array 65 is disposed in the light guide plate 67 for conversion part, and thereby the distance between the reflection mirror 64 and the microlens array 65 is increased. Furthermore, the microlens array 65 is large and long. Therefore, in order to reliably guide the laser light over the entire length of the microlens array 65, the reflection mirror 64 is vibrated by the mirror drive mechanism 66 to broaden the laser light so that the laser light is applied to the entire surface in the longitudinal direction of the microlens array 65.

Further, the light guide plate 67 for conversion part is a flat plate which is hollow inside and has a trapezoidal outer shape, and the length of the lower base of the trapezoid is equal to the length of one end surface of the end-surface incident type light guide plate 52 and to the length of the optical path conversion part 62. The optical path conversion part 62 is disposed in close connection with the end surfaces of the light guide plate 67 for conversion part and the end-surface incident type light guide plate 52. The microlens array 65 is disposed in the vicinity of the upper base of the light guide plate 67 for conversion part.

The laser light which is expanded through the microlens array 65 repeats reflection and diffusion in the light guide plate 67 for conversion part and then enters in the optical path conversion part 62, wherein the path of the laser light is bent so as to be incident on the first light guide plate 53 of the end-surface incident type light guide plate 52. The laser light propagates in the first light guide plate 53 while being reflected and diffused to be incident on the second light guide plate 54, and it is diffused in the second light guide plate 54 to be incident on the liquid crystal display panel unit 2 with a luminance that is uniform over the entire surface.

In the multi-panel LCD according to the modification of the third embodiment, the interference state of the laser light can be temporally varied by vibrating the reflection mirror 64, thereby reducing the influence of speckle noise which is caused by the interference of the laser light.

While in the multi-panel LCD of this modification the light guide plate 67 for conversion part is a trapezoidal and hollow plate having the microlens array 65 inside, the present invention is not restricted thereto. For example, the microlens array 65 may be dispensed with. Further, a fly-eye lens or a liquid crystal element may be used instead of the microlens array.

### Embodiment 4

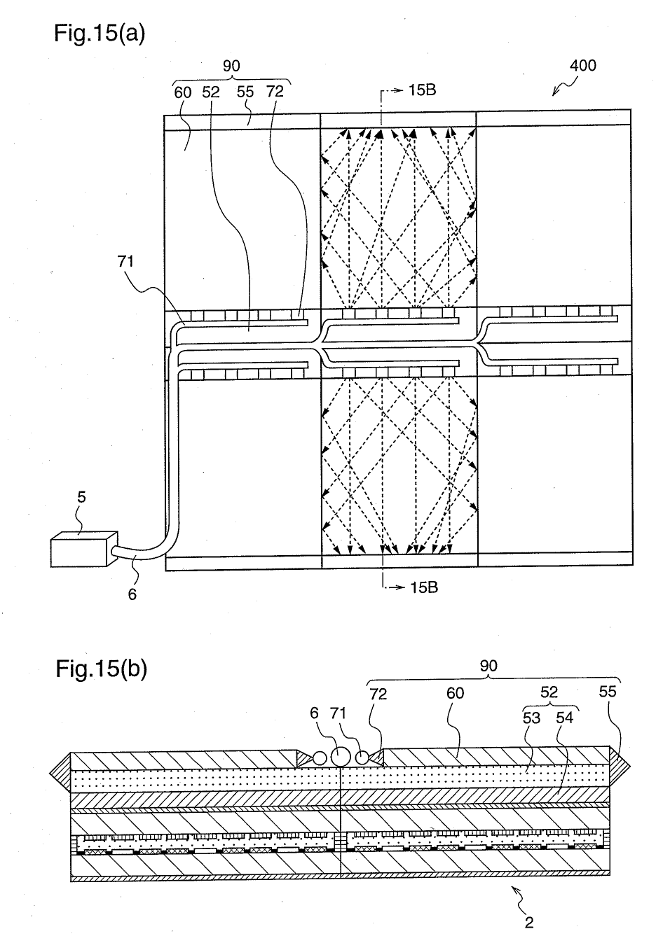

FIG. 15 is a diagram for explaining the configuration of a multi-panel LCD 400 according to a fourth embodiment of the present invention, wherein FIG. 15(a) is a plan view seen from the planar light source unit 71 side, and FIG. 15(b) is a cross-sectional view taken along a line 15B-15B shown in FIG. 15(a). The multi-plane LCD 400 of this fourth embodiment is configured such that the display units are arranged by two planes in the vertical direction and three planes in the horizontal direction, i.e., six units in total.

The multi-panel LCD 400 of this fourth embodiment is similar in the general configuration to the multi-panel LCD 300 of the third embodiment, except the configuration for supplying the laser light from the optical fiber 7 through the laser light guide part 72 to the light guide plate 60 for conversion part. Hereinafter, the difference will be mainly described.

The laser light emitted from the laser light source unit 5 is supplied to the respective planar light source units 90 through the optical fiber unit 6 and the optical fiber lead part 71 which is led from the optical fiber unit 6. In this fourth embodiment, the optical fiber lead part 71 which is branched and led from the optical fiber unit 6 is extended along a side of the light guide plate 60 for conversion part. Laser light guide parts 72 comprising a transparent material are disposed between the optical fiber lead part 71 and the light guide plate 60 for conversion part. Each laser light guide part 72 has a wedge shape, and a pressure is applied to the optical fiber lead part 71 at the front end of the wedge to generate leakage light to be applied to the light guide plate 60 for conversion part. A plurality of laser light guide parts 72 (four in FIG. 15) are disposed along a side of the light guide plate 60 for conversion part. As for the configurations of the laser light source unit 5 and the optical fiber unit 6, the various configurations described for the first embodiment can be similarly used.

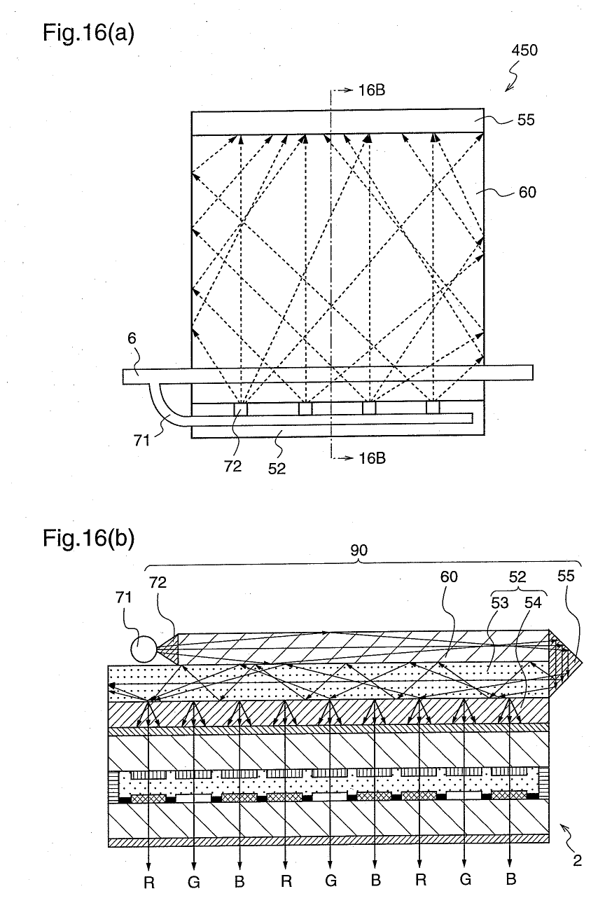

FIG. 16 is a diagram illustrating the configuration of a display unit 450 in the multi-panel LCD 400 of the fourth embodiment, wherein FIG. 16(a) is a plan view seen from the planar light source unit 90 side, and FIG. 16(b) is a cross-sectional view taken along a line 16B-16B shown in FIG. 16(a).

As shown in FIG. 16, the multi-panel LCD 400 of this fourth embodiment is different from the multi-panel LCD 300 of the third embodiment in that a plurality of laser light guide parts 72 (four in FIG. 16) are disposed over the entire length of one side of the light guide plate 60 for conversion part, and laser light is applied to the light guide plate 60 for conversion part through these laser light guide parts 72. Accordingly, the laser light can be applied more uniformly to the light guide plate 60 for conversion part, and thereby the laser light emitted from the end-surface incident type light guide plate 52 has a uniform luminance distribution. Moreover, even when the display unit is increased in size, the laser light can be easily and uniformly applied to the light guide plate 60 for conversion part by arranging a plurality of laser light guide parts 72 at constant pitches.

As shown in FIGS. 15 and 16, in the multi-panel LCD 400 of this fourth embodiment, the planar light source unit 90 is configured such that only the optical path conversion part 55 protrudes over the liquid crystal display panel unit 2. However, by disposing the optical path conversion part 55 in the peripheral region as shown in FIG. 15, even when the multi-panel configuration is adopted, the joint between panels is restricted by only the seal layer of the liquid crystal display panel unit 2 and the connection area for connecting the driver with the TFT, and it is not restricted by the planar light source unit 71. Thereby, the laser light can be uniformly applied over the entire display surface of the liquid crystal display panel unit 2.

As for the configurations of the laser light source unit and the optical fiber, the various configurations described for the first embodiment can be similarly used.

While in this fourth embodiment six display units are used, the present invention is not restricted thereto. For example, a configuration of 2 units×4 units may be adopted. Alternatively, a configuration of 3 units×3 units is also available. However, when the 3 units×3 units configuration is adopted, the width of the optical path conversion part must be minimized to make the joints inconspicuous.

### Embodiment 5

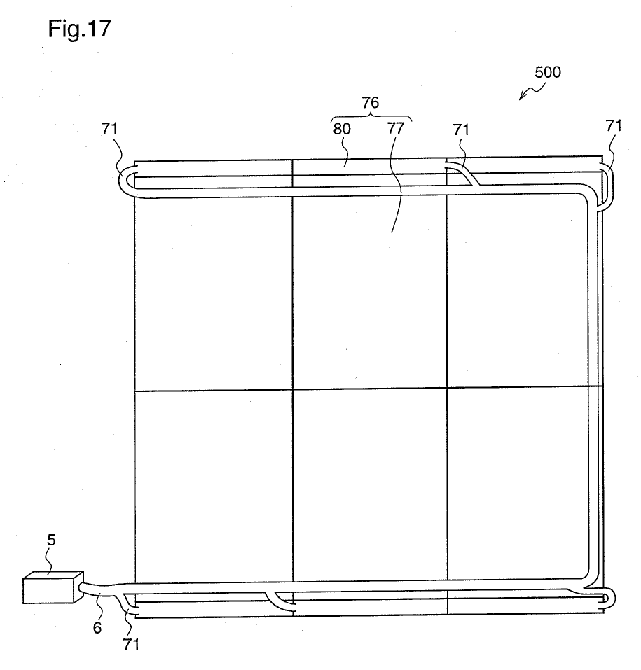

FIG. 17 is a diagram for explaining the configuration of a multi-panel LCD 500 according to a fifth embodiment of the present invention, which is a plan view seen from the planar light source unit 76 side. The multi-panel LCD 500 of this fifth embodiment is configured such that the display units are arranged by two planes in the vertical direction and three planes in the horizontal direction, i.e., six units in total.

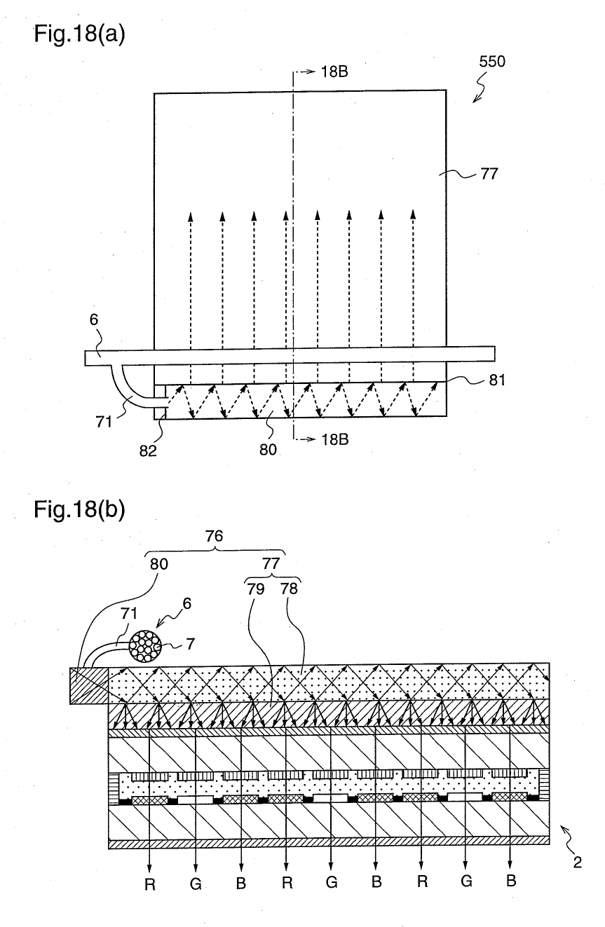

Further, FIG. 18 is a diagram illustrating the configuration of a display unit 550 in the multi-panel LCD 500 of this fifth embodiment, wherein FIG. 18(a) is a plan view seen from the planar light source unit 76 side, and FIG. 18(b) is a cross-sectional view taken along a line 18B-18B shown in FIG. 18(a).

The multi-panel LCD 500 of this fifth embodiment comprises a plurality of liquid crystal display panel units 2, planar light source units 76 which are disposed in close contact with the rear surfaces of the respective liquid crystal display panel units 2, a laser light source unit 5 which supplies laser light for illumination to the planar light source units 76, and an optical fiber unit 6 which guides the laser light from the laser light source unit 5 to the respective planar light source units 76. As for the configurations of the laser light source unit 5 and the optical fiber 6, the various configurations described for the first embodiment can be similarly used.

The planar light source unit 76 is configured including a flat end-surface incident type light guide plate 77 which is closely connected to the liquid crystal display panel unit at its one main surface, and receives the laser light at its one end surface and outputs the laser light from the one main surface, and a light guide member 80 which is closely connected to the one end surface of the end-surface incident type light guide plate 77, and guides the laser light in the direction parallel to the one end surface of the end-surface incident type light guide plate 77 so as to make the light incident on the one end surface.

As shown in FIG. 17, the multi-panel LCD 500 of this fifth embodiment is configured by arranging six display units, and the optical fiber lead part 71 that is branched and led from optical fiber unit 6 is extended onto the planar light source unit 76 of each display unit to be optically connected to the end surface of the light guide member 80.

Further, as shown in FIG. 18, the light guide member 80 is optically connected to the end-surface incident type light guide plate 77 at a junction part 81. An end surface 82 of the light guide body 80 has a notch, and an end portion of the optical fiber lead part 71 is optically connected to the light guide member 80 at this notch.

The laser light emitted from the optical fiber lead part 71 is incident on the end surface 82 of the light guide body 80, and propagates in the light guide member 80 while being reflected and diffused to be incident on the end-surface incident type light guide plate 77 through the junction part 81. The end-surface incident type light guide plate 77 comprises a first light guide plate 78 which transmits the laser light while reflecting and diffusing the same, and a second light guide plate 79 which diffuses the laser light supplied from the first light guide plate 78 to uniformize the same over the entire surface. Accordingly, the laser light incident on the end-surface incident type light guide plate 77 can illuminate the liquid crystal display panel 2 with a uniform luminance.

While in this fifth embodiment 6 display units are used, the present invention is not restricted thereto. For example, a configuration of 2 units×4 units may be adopted. Alternatively, a configuration of 3 units×3 units is also available. However, when the 3 units×3 units configuration is adopted, the width of the optical path conversion part must be minimized to make the joints inconspicuous.

### Embodiment 6

Next, a multi-panel LCD according to a sixth embodiment of the present invention will be described.

The multi-panel LCD of this sixth embodiment provides a configuration for guiding laser light from the light source unit to the planar light source units of the respective display units in the multi-panel LCD according to any of the first to fifth embodiments.

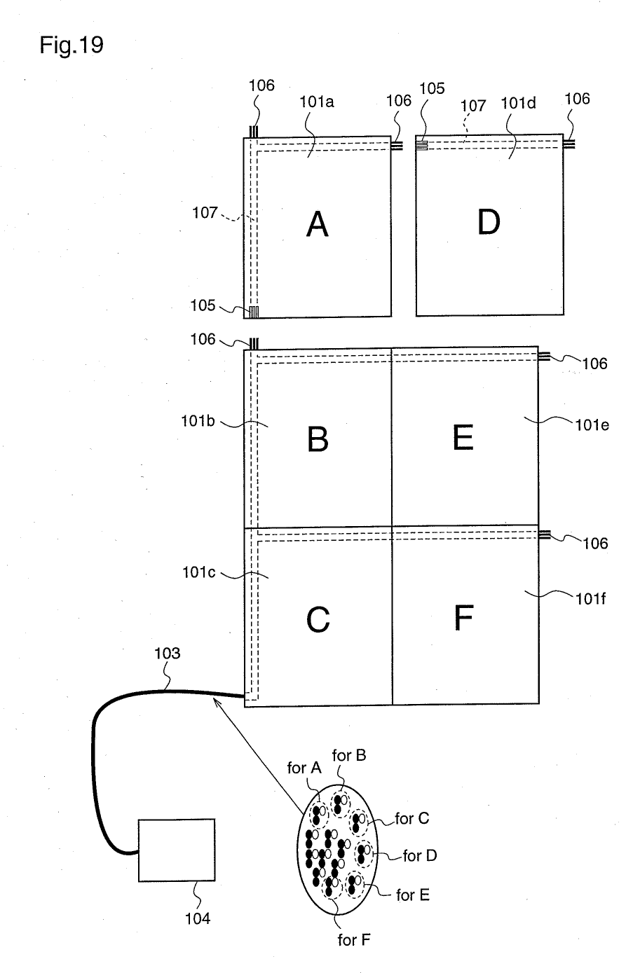

As shown in FIG. 19, in this sixth embodiment, each of the planar light source units 101a to 101f of the display units A to F of the multi-panel LCD includes an input light connector 105 which receive laser light, an output light connector 106 which outputs the laser light, and a connection optical fiber 107 which connects the input light connector 105 with the output light connector 106, and the fiber bundle from the light source 104 is designed such that the laser light for each panel which is outputted from the light source 104 is directly connected to the panel through the fiber and the connectors.

In the multi-panel LCD of this sixth embodiment, the planar light source unit 101 of each display unit includes the input light connector 105, the output light connector 106, and the connection optical fiber 107, and the laser light outputted from the laser light source unit is guided to the planar light source unit of each display unit. Therefore, it is not necessary to draw the fiber bundle outside the planar light source units in order to guide the laser light from the light source to the respective planar light source units, and thereby the whole configuration of the multi-panel LCD obtained by arranging the plural display units can be simplified.

### Embodiment 7

Next, a multi-panel LCD according to a sixth embodiment of the present invention will be described.

The multi-panel LCD of this seventh embodiment provides a configuration for enhancing the safety when the panel or fiber is damaged in the multi-panel LCD according to any of the first to fifth embodiments.

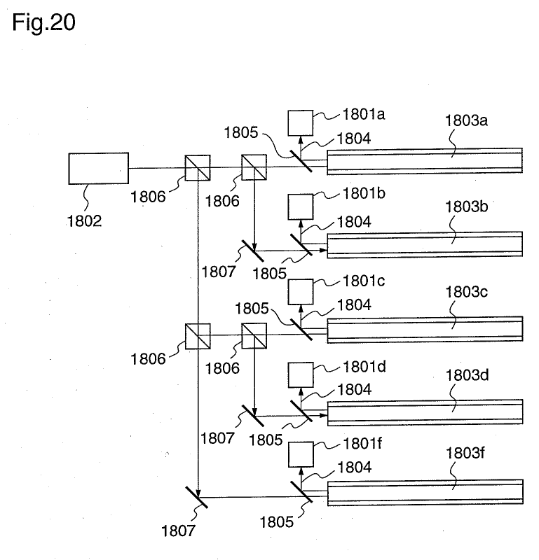

FIG. 20 is a diagram illustrating the configuration of a part of the laser light source in the multi-panel LCD of this seventh embodiment. In FIG. 20, 1802 denotes a multiplexing mechanism, 1806 denotes beam splitters, 1807 denotes reflection mirrors, and 1803 denotes optical fibers. Further, 1805 denotes half mirrors, and 1801 denotes detectors for detecting return light 1804.

In the multi-panel system using the laser light source, if the high-power laser light is leaked to the outside due to damage of the panel or the fiber, the safety is degraded.

In the multi-panel LCD of this seventh embodiment, as shown in FIG. 20, the detectors 1801a to 1801f for detecting the return lights 1804 from the multi-panel are provided for the fibers 1803a to 1803f, respectively. When the fiber or the panel is damaged, the return light to the fiber increases. In this seventh embodiment, the signal of this return light is detected, and supply of light to the fiber with increased return light is reduced or halted, thereby preventing leakage of light from the damage position.

In the multi-panel LCD of this seventh embodiment, the reflected light intensity of the laser light supplied to the optical fiber of the fiber unit is detected, and the intensity of the laser light supplied to the optical fiber is controlled according to the reflected light intensity. Therefore, when the fiber or the panel is damaged, leakage of light from the damage position is avoided to ensure the safety.

While in the first to seventh embodiments the optical fiber of the optical fiber unit may be a multi-mode fiber or a bundle fiber obtained by bundling plural multi-mode fibers. This configuration can reduce the speckle noise in the planar light source panel. While the speckle noise is caused by interference of laser, it can be reduced by temporally varying the interference state of the laser. The laser light which propagates through the multi-mode fiber has plural waveguide modes. The states of the waveguide modes are temporally varied by changing the laser coupling condition or moving the fiber. Thereby, the state of the light propagated to the light source panel is varied and the interference state is temporally varied, resulting in a reduction in the speckle noise. Further, when the bundle fiber is used, the states of the waveguide modes are further increased, and thereby the interference pattern is more complicated to enhance the speckle noise reduction effect.

### APPLICABILITY IN INDUSTRY

A multi-panel LCD of the present invention is configured such that a plurality of display units each comprising a liquid crystal display panel unit and a planar light source unit are arranged, and a laser light source unit which is placed in a different location is used as a light source for these planar light source units to supply laser light to the respective planar light source units through an optical fiber unit. Thereby, a reduction in reliability due to such as luminance degradation in the illumination light source for the liquid crystal display panel units hardly occurs even when the screen size is increased, and the laser light sources in the laser light source unit can be easily replaced, and therefore, it is useful as a large-screen display device.

1. A multi-panel type liquid crystal display device comprising:
a plurality of liquid crystal display panel units which are placed in a predetermined arrangement to configure a multi-panel;
a plurality of planar light source units which are disposed in close contact with the rear surfaces of the respective liquid crystal display panel units, and illuminate the display surfaces of the liquid crystal display panel units;
a laser light source unit which supplies laser light for illumination to the plural planar light source units; and
an optical fiber unit which guides the laser light from the laser light source unit to each of the plural planar light source units.

2. A multi-panel type liquid crystal display device as defined in claim 1 wherein
said planar light source unit comprises:
a flat main-surface incident type light guide plate which is closely connected to the liquid crystal display panel unit at one of its main surfaces, and guides the laser light from the other main surface;
an optical fiber light guide part which is extended from the optical fiber unit, and arranged with being two-dimensionally drawn on the other main surface of the main-surface incident type light guide plate; and
a transparent member which is disposed so as to contact with the other main surface of the main-surface incident type light guide plate and with the optical fiber light guide part, takes out the laser light from the contact portion with the optical fiber light guide part, and guides the taken laser light into the main-surface incident type light guide plate from the contact portion with the other main surface of the main-surface incident type light guide plate.

3. A multi-panel type liquid crystal display device as defined in claim 1 wherein
said planar light source unit comprises:
a flat main-surface incident type light guide plate which is closely connected to the liquid crystal display panel unit at one of its main surfaces, and guides the laser light from the other main surface; and
an optical waveguide which is disposed so as to be two-dimensionally drawn in close contact with the other main surface of the main-surface incident type light guide plate, receives the laser light at its one end part and transits the laser light to the other end part, and guides the laser light from the other main surface of the main-surface incident type light guide plate into the main-surface incident type light guide plate.

4. A multi-panel type liquid crystal display device as defined in claim 1 wherein
said planar light source unit comprises:
a flat end-surface incident type light guide plate which is closely connected to the liquid crystal display panel unit at its one main surface, and receives the laser light at its one end surface and emits the laser light from the one main surface;
an optical path conversion part which is closely connected to the one end surface of the end-surface incident type light guide plate, and converts the optical path of the laser light; and
a laser light guide part which takes out the laser light from the optical fiber unit to guide the laser light into the optical path conversion part.

5. A multi-panel type liquid crystal display device as defined in claim 4 wherein
said laser light guide part comprises:
an optical member which takes out the laser light from the optical fiber unit; and
a light guide plate for the conversion part, which receives the laser light emitted from the optical member at its one end surface, and guides the laser light from the other end surface into the optical path conversion part.

6. A multi-panel type liquid crystal display device as defined in claim 5 wherein
said light guide plate for the conversion part has a reflection layer or a reflection and diffusion layer at its peripheral surface excluding said one end surface and the other end surface.

7. A multi-panel type liquid crystal display device as defined in claim 5 wherein
said optical member includes a microlens array which expands the light flux of the laser light taken out of the optical fiber unit, and applies the laser light to the light guide plate for the conversion part.

8. A multi-panel type liquid crystal display device as defined in claim 5 wherein
said optical member comprises a transparent member which contacts with an optical fiber lead part that is extended from the optical fiber unit and is disposed in parallel with the one end surface of the light guide plate for the conversion part, and takes out the laser light from the contact portion to apply the laser light onto the one end surface of the light guide plate for the conversion part.

9. A multi-panel type liquid crystal display device as defined in claim 1 wherein
said planar light source unit comprises:
a flat end-surface incident type light guide plate which is closely connected to the liquid crystal display panel unit at its one main surface, and receives the laser light at its one end surface and emits the laser light from the one main surface; and
a light guide member which is closely connected to the one end surface of the end-surface incident type light guide plate, and guides the laser light in the direction parallel to the one end surface to apply the laser light onto the one end surface of the end-surface incident type light guide plate.

10. A multi-panel type liquid crystal display device as defined in claim 1 wherein
said optical fiber unit comprises a bundle of plural optical fibers, and one ends of the optical fibers are placed on the laser light source side while the other ends of the optical fibers are placed in the respective planar light source units.

11. A multi-panel type liquid crystal display device as defined in claim 10 wherein
optical switches for selectively guiding the laser light to each of the optical fibers are disposed between the optical fiber unit and the laser light source unit.

12. A multi-panel type liquid crystal display device as defined in claim 11 wherein
each of the optical switches is provided with a light amount control part for controlling the light transmission amount of the laser light to each of the optical fibers.

13. A multi-panel type liquid crystal display device as defined in claim 11 further including
a display control circuit for controlling the respective image displays of the multi-panel, and
an optical switch control circuit for controlling the optical switches on the basis of a signal from the display control circuit, wherein
when selectively displaying the liquid crystal display panel units, the optical switch control circuit turns on the optical switches based on the signal from the display control circuit so as to cut the guided laser light for the liquid crystal display panel units not to be displayed.

14. A multi-panel type liquid crystal display device as defined in claim 12 further including
a display control circuit for controlling the respective image displays of the multi-panel, and
a light amount control circuit for controlling the light amount control parts on the basis of a signal from the display control circuit, wherein
said light amount control circuit controls the amount of the laser light guided to the liquid crystal display panel units by using the light amount control units.

15. A multi-panel type liquid crystal display device as defined in claim 1 wherein
said optical fiber unit comprises:
an optical fiber; and
a light branch part which is placed close to the planar light source unit, branches the laser light to take out the same from the optical fiber, and guides the laser light to the planar light source unit.

16. A multi-panel type liquid crystal display device as defined in claim 1 wherein
said laser light source unit includes at least a laser light source which emits red laser light, a laser light source which emits blue laser light, and a laser light source which emits green laser light.

17. A multi-panel type liquid crystal display device as defined in claim 16 wherein
said laser light source unit includes a multiplexing mechanism which multiplexes the laser lights emitted from the plural laser light sources to make a single beam.

18. A multi-panel type liquid crystal display device as defined in claim 1 wherein
each of the planar light source units includes:
an input light connector which receives laser light;
an output light connector which outputs the laser light; and
an optical fiber which connects the input light connector and the output light connector; and
the laser light outputted from the laser light source unit is guided to the respective planar light source units of the respective liquid crystal display panel units which constitute a multi-panel, through the input light connectors, the output light connectors, and the optical fibers connecting these connectors.

19. A multi-panel type liquid crystal display device as defined in claim 1 further including
a detector for detecting the reflected light intensity of the laser light supplied to the optical fiber of the fiber unit, wherein
the intensity of the laser light supplied to the optical fiber is controlled according to the reflected light intensity.

20. A multi-panel type liquid crystal display device as defined in claim 1 wherein
the optical fiber of the optical fiber unit is a multi-mode fiber.
